(19) United States
(12) Patent Application Publication
(10) Pub. No.: US 2026/0032290 A1
(43) Pub. Date: Jan. 29, 2026

(54) IMAGE FILTERING METHOD AND APPARATUS BASED ON NEURAL NETWORK, AND DEVICE AND STORAGE MEDIUM

(71) Applicant: TENCENT TECHNOLOGY (SHENZHEN) COMPANY LIMITED, SHENZHEN (CN)

(72) Inventors: Renjie CHANG, SHENZHEN (CN); Liqiang WANG, SHENZHEN (CN)

(73) Assignee: TENCENT TECHNOLOGY (SHENZHEN) COMPANY LIMITED, SHENZHEN (CN)

(21) Appl. No.: 19/345,009

(22) Filed: Sep. 30, 2025

Related U.S. Application Data
(63) Continuation of application No. PCT/CN2024/104314, filed on Jul. 8, 2024.

(30) Foreign Application Priority Data
Jul. 28, 2023 (CN) 202310944920.8

(51) Int. Cl. H04N 19/82; H04N 19/136; H04N 19/42

(52) U.S. Cl. CPC H04N 19/82; H04N 19/136; H04N 19/42

(57) ABSTRACT

The present disclosure describes methods, apparatus, and computer readable medium for video filtering, coding, and/or decoding. One method includes generating an input parameter of a neural network based on a to-be-filtered image; filtering the to-be-filtered image based on the input parameter through the neural network, the neural network comprising a residual network for extracting image feature information, the residual network comprising a plurality of residual blocks sequentially connected to each other, each residual block comprising a plurality of convolutional layers that are arranged in parallel and that have different convolution kernel sizes, the residual network comprising a first set convolutional layer and a second set convolutional layer that are alternately arranged, and the first set convolutional layer being different from the second set convolutional layer; and outputting a filtered image corresponding to the to-be-filtered image from the neural network corresponding to the to-be-filtered image.

### RELATED APPLICATION

This application is a continuation application of PCT Patent Application No. PCT/CN2024/104314, filed on Jul. 8, 2024, which claims priority to Chinese Patent Application No. 202310944920.8, filed with the Chinese National Intellectual Property Administration on Jul. 28, 2023, both of which are incorporated herein by reference in their entireties.

### FIELD OF THE TECHNOLOGY

The present disclosure relates to the field of image coding and decoding technologies, and in particular, to a filtering, coding, and/or decoding method and apparatus, and an electronic device.

### BACKGROUND OF THE DISCLOSURE

In the field of video coding and decoding, a predicted image and a reconstructed residual image are superimposed to generate a reconstructed image. Since the reconstructed image may have distortion, to obtain an image with good quality, loop filtering usually needs to be performed on the reconstructed image. However, during the loop filtering, how to enhance a filtering effect to improve coding and decoding efficiency is a technical problem that needs to be solved urgently.

The present disclosure describes embodiments for filtering, decoding, and encoding video data, addressing at least one of the problems/issues discussed above, improving video coding/decoding efficiency and/or improving the field of video transmission.

### SUMMARY

Embodiments of the present disclosure provide a filtering, coding, and/or decoding method and apparatus, and an electronic device, which can reduce impact of asymmetry introduced by decomposition and enhance a filtering effect while reducing operation complexity of a neural network filter, thereby facilitating improving video coding and decoding efficiency.

Other features and advantages of the present disclosure become apparent through the following detailed descriptions, or may be partially learned through the practice of the present disclosure.

The present disclosure describes a method for video decoding. The method includes generating, by a device, an input parameter of a neural network based on a to-be-filtered image. The device includes a memory storing instructions and a processor in communication with the memory. The method further includes: filtering, by the device, the to-be-filtered image based on the input parameter through the neural network, the neural network comprising a residual network for extracting image feature information, the residual network comprising a plurality of residual blocks sequentially connected to each other, each residual block comprising a plurality of convolutional layers that are arranged in parallel and that have different convolution kernel sizes, the residual network comprising a first set convolutional layer and a second set convolutional layer that are alternately arranged, and the first set convolutional layer being different from the second set convolutional layer; and outputting, by the device, a filtered image corresponding to the to-be-filtered image from the neural network corresponding to the to-be-filtered image

The present disclosure describes an apparatus for video decoding. The apparatus includes a memory storing instructions; and a processor in communication with the memory. When the processor executes the instructions, the processor is configured to cause the apparatus to perform: generating an input parameter of a neural network based on a to-be-filtered image; filtering the to-be-filtered image based on the input parameter through the neural network, the neural network comprising a residual network for extracting image feature information, the residual network comprising a plurality of residual blocks sequentially connected to each other, each residual block comprising a plurality of convolutional layers that are arranged in parallel and that have different convolution kernel sizes, the residual network comprising a first set convolutional layer and a second set convolutional layer that are alternately arranged, and the first set convolutional layer being different from the second set convolutional layer; and outputting a filtered image corresponding to the to-be-filtered image from the neural network corresponding to the to-be-filtered image.

The present disclosure describes a non-transitory computer-readable storage medium, storing computer-readable instructions. The computer-readable instructions, when executed by a processor, are configured to cause the processor to perform: generating an input parameter of a neural network based on a to-be-filtered image; filtering the to-be-filtered image based on the input parameter through the neural network, the neural network comprising a residual network for extracting image feature information, the residual network comprising a plurality of residual blocks sequentially connected to each other, each residual block comprising a plurality of convolutional layers that are arranged in parallel and that have different convolution kernel sizes, the residual network comprising a first set convolutional layer and a second set convolutional layer that are alternately arranged, and the first set convolutional layer being different from the second set convolutional layer; and outputting a filtered image corresponding to the to-be-filtered image from the neural network corresponding to the to-be-filtered image.

According to another aspect of the embodiments of the present disclosure, a filtering method based on a neural network is provided, applied to a filtering device and including: generating an input parameter of a neural network filter based on a to-be-filtered image; filtering the to-be-filtered image based on the input parameter through the neural network filter, the neural network filter including a residual unit for extracting image feature information, the residual unit including a plurality of residual blocks sequentially connected to each other, each residual block at least including a plurality of convolutional layers that are arranged in parallel and that have different convolution kernel sizes, the residual unit including a first set convolutional layer and a second set convolutional layer that are alternately arranged, and the first set convolutional layer being different from the second set convolutional layer; and obtaining a filtered image, outputted by the neural network filter, for the to-be-filtered image.

According to an aspect of the embodiments of the present disclosure, a video coding method is provided, applied to a coding device and including: generating an input parameter of a neural network filter based on a to-be-filtered reconstructed image; processing the reconstructed image based on the input parameter through the neural network filter, the neural network filter including a residual unit for extracting image feature information, the residual unit including a plurality of residual blocks sequentially connected to each other, each residual block at least including a plurality of convolutional layers that are arranged in parallel and that have different convolution kernel sizes, the residual unit including a first set convolutional layer and a second set convolutional layer that are alternately arranged, and the first set convolutional layer being different from the second set convolutional layer; obtaining a filtered image, outputted by the neural network filter, for the reconstructed image; and generating a predicted image corresponding to a next frame of image based on the filtered image, and coding the next frame of video image based on the predicted image corresponding to the next frame of image.

According to an aspect of the embodiments of the present disclosure, a video decoding method is provided, applied to a decoding device and including: generating an input parameter of a neural network filter based on a to-be-filtered reconstructed image; filtering the reconstructed image based on the input parameter through the neural network filter, the neural network filter including a residual unit for extracting image feature information, the residual unit including a plurality of residual blocks sequentially connected to each other, each residual block at least including a plurality of convolutional layers that are arranged in parallel and that have different convolution kernel sizes, the residual unit including a first set convolutional layer and a second set convolutional layer that are alternately arranged, and the first set convolutional layer being different from the second set convolutional layer; obtaining a filtered image, outputted by the neural network filter, for the reconstructed image; and generating a predicted image corresponding to a next frame of image based on the filtered image, and decoding a video stream based on the predicted image corresponding to the next frame of image.

According to an aspect of the embodiments of the present disclosure, a filtering apparatus based on a neural network is provided, applied to a filtering device and including: a generation unit, configured to generate an input parameter of a neural network filter based on a to-be-filtered image; a processing unit, configured to filter the reconstructed image based on the input parameter through the neural network filter, the neural network filter including a residual unit for extracting image feature information, the residual unit including a plurality of residual blocks sequentially connected to each other, each residual block at least comprising a plurality of convolutional layers that are arranged in parallel and that have different convolution kernel sizes, the residual unit including a first set convolutional layer and a second set convolutional layer that are alternately arranged, and the first set convolutional layer being different from the second set convolutional layer; and an obtaining unit, configured to obtain a filtered image, outputted by the neural network filter, for the to-be-filtered image.

In some embodiments of the present disclosure, based on the foregoing solution, at least one of the first set convolutional layer and the second set convolutional layer includes a convolutional layer obtained by performing decomposition through a tensor decomposition mode, and decomposition orders of the first set convolutional layer and the second set convolutional layer are different.

In some embodiments of the present disclosure, based on the foregoing solution, the input parameter includes at least one type of the following information:
boundary strength information, a slice quantization parameter, a base quantization parameter, a frame type of the to-be-filtered image, and a predicted image corresponding to the to-be-filtered image when the to-be-filtered image is a reconstructed image.

In some embodiments of the present disclosure, based on the foregoing solution, the plurality of convolutional layers include a first convolutional layer and a second convolutional layer; each residual block further includes a first activation function layer connected to the first convolutional layer, a second activation function layer connected to the second convolutional layer, and a third convolutional layer and a fourth convolutional layer that are sequentially connected, and an output end of the first activation function layer and an output end of the second activation function layer are connected to an input end of the third convolutional layer; the first convolutional layer and the second convolutional layer receive feature information of the input parameter; the feature information of the input parameter includes the image feature information; the first activation function layer and the second activation function layer are a same activation function layer or two activation function layers independent of each other; and an input parameter of the residual block and output data of the fourth convolutional layer are superimposed and are used as output data of the residual block.

In some embodiments of the present disclosure, based on the foregoing solution, the two first convolutional layers of two adjacent residual blocks are respectively the first set convolutional layer and the second set convolutional layer, and/or the two fourth convolutional layers of two adjacent residual blocks are respectively the first set convolutional layer and the second set convolutional layer; alternatively, for the same residual block, the first convolutional layer is the first set convolutional layer, and the fourth convolutional layer is the second set convolutional layer.

In some embodiments of the present disclosure, based on the foregoing solution, a convolution kernel size of the first convolutional layer is n×n; and a convolution kernel size of the second convolutional layer is m×m, m and n being integers greater than or equal to 1, and m≠n.

In some embodiments of the present disclosure, based on the foregoing solution, the first convolutional layer includes: two convolutional sublayers obtained by decomposing the convolutional layer with the convolution kernel size of n×n through the tensor decomposition mode; and a convolution kernel size of the second convolutional layer is m×m, m and n being integers greater than or equal to 1, and m≠n.

In some embodiments of the present disclosure, based on the foregoing solution, the two convolutional sublayers include: a convolutional layer with a convolution kernel size of 1×n, and a convolutional layer with a convolution kernel size of n×1.

In some embodiments of the present disclosure, based on the foregoing solution, the first convolutional layer includes: two convolutional sublayers obtained by decomposing the convolutional layer with the convolution kernel size of n×n through tensor decomposition and group convolution; and a convolution kernel size of the second convolutional layer is m×m, m and n being integers greater than or equal to 1, and m≠n.

In some embodiments of the present disclosure, based on the foregoing solution, the two convolutional sublayers include: a convolutional layer that has a convolution kernel size of 1×n and that performs group convolution, and a convolutional layer that has a convolution kernel size of n×1 and that performs group convolution.

In some embodiments of the present disclosure, based on the foregoing solution, the first convolutional layer includes: three convolutional sublayers obtained by decomposing the convolutional layer with the convolution kernel size of n×n through tensor decomposition and depth-wise separable convolution; and a convolution kernel size of the second convolutional layer is m×m, m and n being integers greater than or equal to 1, and m≠n.

In some embodiments of the present disclosure, based on the foregoing solution, the three convolutional sublayers include: a convolutional layer/sublayer that has a convolution kernel size of 1×n and that performs group convolution, a convolutional layer/sublayer that has a convolution kernel size of n×1 and that performs group convolution, and a convolutional layer/sublayer with a convolution kernel size of 1×1.

In some embodiments of the present disclosure, based on the foregoing solution, a convolution kernel size of the fourth convolutional layer is k×k; alternatively,
the fourth convolutional layer includes two convolutional sublayers obtained by decomposing the convolutional layer with the convolution kernel size of k×k through the tensor decomposition mode; alternatively,
the fourth convolutional layer includes a convolutional sublayer obtained by decomposing the convolutional layer with the convolution kernel size of k×k through group convolution; alternatively,
the fourth convolutional layer includes two convolutional sublayers obtained by decomposing the convolutional layer with the convolution kernel size of k×k through depth-wise separable convolution; alternatively,
the fourth convolutional layer includes two convolutional sublayers obtained by decomposing the convolutional layer with the convolution kernel size of k×k through tensor decomposition and group convolution; alternatively,
the fourth convolutional layer includes three convolutional sublayers obtained by decomposing the convolutional layer with the convolution kernel size of k×k through tensor decomposition and depth-wise separable convolution,
k being an integer greater than or equal to 1.

In some embodiments of the present disclosure, based on the foregoing solution, the neural network filter further includes: a shallow feature extraction unit, the shallow feature extraction unit including at least one convolutional layer, and the shallow feature extraction unit being configured to: extract shallow feature information of the input parameter and input the shallow feature information to the residual unit.

In some embodiments of the present disclosure, based on the foregoing solution, the input parameter includes a plurality of types of information; the at least one convolutional layer includes a plurality of shallow feature extraction convolutional layers; each type of information corresponds to at least one shallow feature extraction convolutional layer; and the shallow feature extraction convolutional layer is configured for extracting shallow feature information of corresponding information.

In some embodiments of the present disclosure, based on the foregoing solution, the input parameter includes a plurality of types of information; the shallow feature extraction unit further includes a connection layer; the connection layer is configured for: connecting the plurality of types of information and inputting the plurality of types of information that are connected to the at least one convolutional layer; and the at least one convolutional layer is configured for: extracting shallow feature information of the plurality of types of information that are connected, and inputting the shallow feature information to the residual unit.

In some embodiments of the present disclosure, based on the foregoing solution, the residual unit is simultaneously specific to both an image luminance component and an image chrominance component;
the neural network filter further includes: feature mapping units respectively specific to an image luminance component and an image chrominance component and configured to map image feature information outputted by the residual unit; the feature mapping unit specific to the image luminance component and the feature mapping unit specific to the image chrominance component respectively process output data of the residual unit.

In some embodiments of the present disclosure, based on the foregoing solution, the residual unit includes residual units respectively specific to an image luminance component and an image chrominance component; and the neural network filter further includes: feature mapping units respectively specific to an image luminance component and an image chrominance component and configured to map image feature information outputted by the residual unit; the feature mapping unit specific to the image luminance component processes output data of the residual unit for the image luminance component; and the feature mapping unit specific to the image chrominance component processes output data of the residual unit for the image chrominance component.

According to an aspect of the embodiments of the present disclosure, a video coding apparatus is provided, applied to a coding device and including: a generation unit, configured to generate an input parameter of a neural network filter based on a to-be-filtered reconstructed image; a processing unit, configured to process the reconstructed image based on the input parameter through the neural network filter, the neural network filter including a residual unit for extracting image feature information, the residual unit including a plurality of residual blocks sequentially connected to each other, each residual block at least including a plurality of convolutional layers that are arranged in parallel and that have different convolution kernel sizes, the residual unit including a first set convolutional layer and a second set convolutional layer that are alternately arranged, and the first set convolutional layer being different from the second set convolutional layer; an obtaining unit, configured to obtain a filtered image, outputted by the neural network filter, for the reconstructed image; and a coding unit, configured to: generate a predicted image corresponding to a next frame of image based on the filtered image, and code the next frame of video image based on the predicted image corresponding to the next frame of image.

According to an aspect of the embodiments of the present disclosure, a video decoding apparatus is provided, applied to a decoding device and including: a generation unit, configured to generate an input parameter of a neural network filter based on a to-be-filtered reconstructed image; a processing unit, configured to filter the reconstructed image based on the input parameter through the neural network filter, the neural network filter including a residual unit for extracting image feature information, the residual unit including a plurality of residual blocks sequentially connected to each other, each residual block at least comprising a plurality of convolutional layers that are arranged in parallel and that have different convolution kernel sizes, the residual unit including a first set convolutional layer and a second set convolutional layer that are alternately arranged, and the first set convolutional layer being different from the second set convolutional layer; and an obtaining unit, configured to obtain a filtered image, outputted by the neural network filter, for the reconstructed image; and a decoding unit, configured to: generate a predicted image corresponding to a next frame of image based on the filtered image, and decode a video stream based on the predicted image corresponding to the next frame of image.

According to an aspect of the embodiments of the present disclosure, an electronic device is provided, including: one or more processors; and a storage apparatus (or a memory), configured to store one or more computer programs, when the one or more computer programs being executed by the one or more processors, the electronic device being caused to implement the method as described in the above embodiment.

According to an aspect of the embodiments of the present disclosure, a coder is provided, including a processor and a memory. The memory is configured to store a computer program, and the processor is configured to call and run the computer program stored in the memory to perform the above coding method.

According to an aspect of the embodiments of the present disclosure, a decoder is provided, including a processor and a memory. The memory is configured to store a computer program, and the processor is configured to call and run the computer program stored in the memory to perform the decoding method.

According to an aspect of the embodiments of the present disclosure, a chip is provided, configured to implement the methods in the above embodiments. Specifically, the chip includes: a processor, configured to call and run a computer program from a memory, to cause a device installed with the chip to perform the methods in the above embodiments.

According to an aspect of the embodiments of the present disclosure, a computer-readable storage medium is provided, which is configured to store a computer program, the computer program causing a computer to perform the methods in the above embodiments.

According to an aspect of the embodiments of the present disclosure, a computer program product is provided, including a computer program instruction, the computer program instruction causing a computer to perform the methods in the above embodiments.

According to an aspect of the embodiments of the present disclosure, a computer program is provided, the computer program, when executed on a computer, causing the computer to perform the methods in the above embodiments.

In the technical solutions of some embodiments of the present disclosure, a neural network filter includes a residual unit; the residual unit includes a plurality of residual blocks connected to each other in sequence; each residual block at least includes a plurality of convolutional layers that are arranged in parallel and that have different convolution kernel sizes, so that the neural network filter can obtain feature information on a plurality of stages of receptive fields through the residual blocks, thus improving generalization performance of the neural network filter. The residual unit further includes different convolutional layers that are alternately arranged, which can reduce impact of asymmetry introduced by decomposition and enhance a filtering effect while reducing operation complexity of a neural network filter, thereby facilitating improving video coding and decoding efficiency.

The foregoing general descriptions and the following detailed descriptions are merely for illustration and explanation purposes and are not intended to limit the present disclosure.

### BRIEF DESCRIPTION OF THE DRAWINGS

FIG. 1 is a schematic diagram of an exemplary system architecture to which the technical solutions in the embodiments of the present disclosure may be applied.

FIG. 2 is a schematic diagram of arrangement modes of a video coding apparatus and a video decoding apparatus in a streaming transmission system.

FIG. 3 is a basic flowchart of a video coder.

FIG. 4 is a schematic diagram of filtering based on a neural network loop filter (NNLF).

FIG. 5 is a schematic diagram of filtering being performed on a luminance component and a chrominance component.

FIG. 6 is a schematic diagram of filtering being performed on a luminance component and a chrominance component.

FIG. 7 is a flowchart of a filtering method based on a neural network according to an embodiment of the present disclosure.

FIG. 8 is a schematic diagram of a decomposition mode according to a canonical polyadic decomposition (CPD).

FIG. 9 is a schematic diagram of an alternate decomposition mode according to a CPD.

FIG. 10 is a schematic structural diagram of a residual block according to an embodiment of the present disclosure.

FIG. 11 is a schematic structural diagram of a residual block according to an embodiment of the present disclosure.

FIG. 12 is a flowchart of a video coding method according to an embodiment of the present disclosure.

FIG. 13 is a flowchart of a video decoding method according to an embodiment of the present disclosure.

FIG. 14 is a schematic structural diagram of a neural network filter according to an embodiment of the present disclosure.

FIG. 15 is a schematic structural diagram of a neural network filter according to an embodiment of the present disclosure.

FIG. 16 is a schematic structural diagram of a residual block according to an embodiment of the present disclosure.

FIG. 17 is a schematic structural diagram of a residual block according to an embodiment of the present disclosure.

FIG. 18 is a schematic structural diagram of a residual block according to an embodiment of the present disclosure.

FIG. 19 is a schematic structural diagram of a neural network filter according to an embodiment of the present disclosure.

FIG. 20 is a schematic structural diagram of a neural network filter according to an embodiment of the present disclosure.

FIG. 21 is a schematic structural diagram of a neural network filter according to an embodiment of the present disclosure.

FIG. 22 is a schematic structural diagram of a neural network filter according to an embodiment of the present disclosure.

FIG. 23 is a schematic structural diagram of a neural network filter according to an embodiment of the present disclosure.

FIG. 24 is a schematic structural diagram of a neural network filter according to an embodiment of the present disclosure.

FIG. 25 is a schematic structural diagram of a neural network filter according to an embodiment of the present disclosure.

FIG. 26 is a schematic structural diagram of a neural network filter according to an embodiment of the present disclosure.

FIG. 27 is a block diagram of a filtering apparatus based on a neural network according to an embodiment of the present disclosure.

FIG. 28 is a block diagram of a video coding apparatus according to an embodiment of the present disclosure.

FIG. 29 is a block diagram of a video decoding apparatus according to an embodiment of the present disclosure.

FIG. 30 is a schematic structural diagram of a computer system adapted to implement an electronic device according to an embodiment of the present disclosure.

### DESCRIPTION OF EMBODIMENTS

Exemplary implementations are now described in a more comprehensive manner with reference to the accompanying drawings. However, the exemplary implementations may be implemented in various forms, and are not to be understood as being limited to these examples. On the contrary, the purpose of providing these implementations is to make the present disclosure more comprehensive and complete, and to fully convey the concept of the exemplary implementations to a person skilled in the art.

In addition, the features, structures, or characteristics described in the present disclosure may be combined in one or more embodiments in any appropriate manner. The following description has many specific details, so that the embodiments of the present disclosure can be fully understood. However, a person skilled in the art is to be aware that, technical solutions of the present disclosure may be implemented without using all detailed features in the embodiments, one or more particular details may be omitted, or other methods, elements, apparatuses, or operations may be used.

The block diagrams shown in the accompanying drawings are merely functional entities and do not necessarily correspond to physically independent entities. That is, the functional entities may be implemented in a software form, or in one or more hardware modules or integrated circuits, or in different networks and/or processor apparatuses and/or microcontroller apparatuses.

The flowcharts shown in the accompanying drawings are merely exemplary descriptions, do not need to include all content and operations/steps, and do not need to be performed in the described orders either. For example, some operations/steps may be further divided, while some operations/steps may be combined or partially combined. Therefore, an actual execution order may change according to an actual case.

Here, “multiple” mentioned in the specification means two or more. The term “and/or” is used for describing an association relationship between associated objects and representing that three relationships may exist. For example, A and/or B may represent the following three cases: only A exists, both A and B exist, and only B exists. The character “/” in this specification generally indicates an “or” relationship between the associated objects.

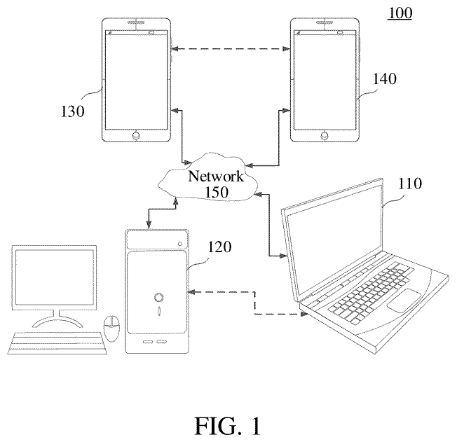

FIG. 1 is a schematic diagram of an exemplary system architecture to which the technical solutions in the embodiments of the present disclosure may be applied.

As shown in FIG. 1, a system architecture 100 includes a plurality of terminal apparatuses. The terminal apparatuses may communicate with each other over, for example, a network 150. For example, the system architecture 100 may include a first terminal apparatus 110 and a second terminal apparatus 120 that are connected to each other through the network 150. In this embodiment of FIG. 1, the first terminal apparatus 110 and the second terminal apparatus 120 perform unidirectional data transmission.

For example, the first terminal apparatus 110 may code video data (e.g., a video picture stream captured by the terminal apparatus 110) for transmission to the second terminal apparatus 120 by using the network 150, coded video data is transmitted in the form of one or more coded video streams, and the second terminal apparatus 120 may receive the coded video data from the network 150, decode the coded video data to restore the video data, and display video pictures according to the restored video data.

In an embodiment of the present disclosure, the system architecture 100 may include a third terminal apparatus 130 and a fourth terminal apparatus 140 that perform two-way transmission of coded video data. The two-way transmission may occur, for example, during a video conference. For two-way data transmission, either of the third terminal apparatus 130 and the fourth terminal apparatus 140 may code video data (e.g., a video picture stream captured by the terminal apparatus) for transmission to the other of the third terminal apparatus 130 and the fourth terminal apparatus 140 by using the network 150. Either of the third terminal apparatus 130 and the fourth terminal apparatus 140 may further receive coded video data transmitted by the other of the third terminal apparatus 130 and the fourth terminal apparatus 140, may decode the coded video data to restore the video data, and may display video pictures on an accessible display apparatus according to the restored video data.

In the embodiment of FIG. 1, the first terminal apparatus 110, the second terminal apparatus 120, the third terminal apparatus 130, and the fourth terminal apparatus 140 may be servers, personal computers, and smart phones, but the principles disclosed in the present disclosure are not limited thereto. The embodiment disclosed in the present disclosure is adapted to a laptop computer, a tablet computer, a media player, and/or a dedicated video conference device. The network 150 represents any quantity of networks that include, for example, wired and/or wireless communication networks, and transmit the coded point cloud data among the first terminal apparatus 110, the second terminal apparatus 120, the third terminal apparatus 130, and the fourth terminal apparatus 140. The communication network 150 may exchange data in circuit-switched and/or packet-switched channels. The network may include telecommunications networks, local area networks, wide area networks and/or the Internet. For the purposes of the present disclosure, unless explained below, an architecture and topology of the network 150 may be immaterial to operations disclosed in the present disclosure.

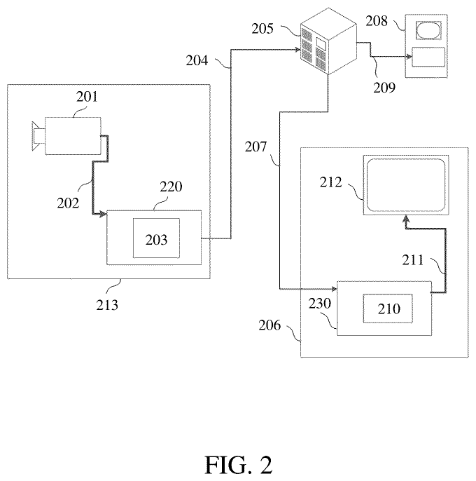

In an embodiment of the present disclosure, FIG. 2 shows arrangement modes of a video coding apparatus and a video decoding apparatus in a streaming transmission environment. The subject matter disclosed in the present disclosure may be equally applicable to other video enabled applications, including, for example, video conferencing, a digital television (TV), and storing of compressed videos on digital media including a compact disc (CD), a digital versatile disc (DVD), a memory stick, and the like.

A streaming transmission system may include a capture subsystem 213. The capture subsystem 213 may include a video source 201 such as a digital camera. The video source creates a video picture stream 202 that is uncompressed. In this embodiment, the video picture stream 202 includes samples that are taken by the digital camera. The video picture stream 202 is depicted as a bold line to emphasize a video picture stream with a high data volume when compared to coded video data 204 (or a coded video stream 204). The video picture stream 202 may be processed by an electronic apparatus 220. The electronic apparatus 220 includes a video coding apparatus 203 coupled to the video source 201. The video coding apparatus 203 may include hardware, software, or a combination of software and hardware, to implement or carry out each aspect of the disclosed subject described below in more details. The coded video data 204 (or the coded video stream 204) is depicted as a thin line to emphasize the coded video data 204 (or the coded video stream 204) with a lower data volume when compared to the video picture stream 202, which may be stored on a streaming server 205 for future use. One or more streaming client subsystems, such as a client subsystem 206 and a client subsystem 208 in FIG. 2, may access the streaming server 205 to retrieve a copy 207 and a copy 209 of the coded video data 204. The client subsystem 206 may include, for example, a video decoding apparatus 210 in an electronic apparatus 230. The video decoding apparatus 210 decodes the input duplicate 207 of the coded video data, and generates an output video picture stream 211 that may be displayed on a display 212 (for example, a display screen) or another display apparatus. In some streaming transmission systems, the coded video data 204, video data 207, and video data 209 (e.g., video streams) may be coded according to certain video coding/compression standards.

The electronic apparatus 220 and the electronic apparatus 230 may include other components not shown. For example, the electronic apparatus 220 may include a video decoding apparatus, and the electronic apparatus 230 may further include a video coding apparatus.

In an embodiment of the present disclosure, by taking international video coding standards such as high efficiency video coding (HEVC) and versatile video coding (VVC) and the Chinese national video coding/encoding standard such as an audio video coding standard (AVS) as examples, when a video image frame is inputted, the video image frame is partitioned into a plurality of non-overlapping processing units according to a block size, and a similar compression operation is performed on each processing unit. The processing unit is referred to as a coding tree unit (CTU) or a largest coding unit (LCU). The CTU may be further partitioned into one or more basic coding units (CU). The CU may be a most basic element in a coding phase.

The following describes some concepts during coding of the CU.

Predictive coding: The predictive coding includes modes such as intra prediction and inter prediction. After an original video signal is predicted by using a selected reconstructed video signal, a residual video signal is obtained. A coder side needs to determine a predictive coding mode to be selected for a current CU, and notify a decoder side. The intra prediction means that a predicted signal comes from a region that has been coded and reconstructed in a same image. The inter prediction means that the predicted signal comes from a coded image (referred to as a reference image) that is different from a current image.

Transform & Quantization: Transform operations such as discrete Fourier transform (DFT) and discrete cosine transform (DCT) are performed on a residual video signal to convert the signal into a transform domain, which is referred to as a transform coefficient. A lossy quantization operation is further performed on the transform coefficient, which loses a specific amount of information, so that the quantized signal facilitates compressed expression. In some video coding standards, more than one transform mode may be selected. Therefore, the coding end also needs to select one of the transform modes for the currently coded CU, and inform the decoding end. Fineness of the quantization is generally determined by a quantization parameter (QP). A larger QP indicates that coefficients with a larger value range are to be quantized into a same output, which may generally bring greater distortion and a lower bit rate. On the contrary, a smaller value of QP indicates that coefficients in a smaller value range are to be quantized into the same output, which therefore usually brings less distortion and corresponds to a higher bit rate.

Entropy coding or statistical coding: Statistical compression coding is performed on the quantized signal in the transform domain according to a frequency of occurrence of each value, and finally a binarized (0 or 1) compressed stream is outputted. In addition, entropy coding also needs to be performed on other information generated through coding, for example, a selected coding mode and motion vector data, to reduce the code rate. Statistical coding is a lossless coding mode that can effectively reduce a bit rate desired for expressing a same signal. A common statistical coding mode includes variable length coding (VLC) or context adaptive binary arithmetic coding (CABAC).

A CABAC process mainly includes 3 operations: binarization, context modeling, and binary arithmetic coding. After binarization is performed on an input syntactic element, binary data may be coded in a normal coding mode and a bypass coding mode. The bypass coding mode does not desire assignment of a specific probability model to each binary bit, and an inputted binary bit bin value is directly coded using a simple bypass coder to speed up the entire coding and decoding process. In general, different syntax elements are not completely independent, and identical syntax elements have a memory. Therefore, according to a conditional entropy theory, using other coded syntax elements for conditional coding can further improve coding performance compared with independent coding or memoryless coding. Such coded symbolic information that is used as a condition is referred to as a context. In the regular coding mode, binary bits of a syntax element sequentially enter a context modeler. The coder assigns a suitable probability model for each inputted binary bit according to a value of a previously coded syntax element or binary bit. This process is referred to as context modeling. A context model corresponding to a syntax element may be located by using a context index increment (ctxIdxInc) and a context index start (ctxIdxStart). After the bin value and the assigned probability model are fed together into a binary arithmetic coder for coding, the context model needs to be updated according to the bin value. This is an adaptive process in the coding.

Loop filtering: Operations such as inverse quantization, inverse transform, and predictive compensation are performed on a transformed and quantized signal to obtain a reconstructed image. The reconstructed image has some information different from that in an original image as a result of quantization, that is, the reconstructed image may cause distortion. Therefore, a filtering operation may be performed on the reconstructed image, for example, by using filters such as a deblocking filter (DB), a sample adaptive offset (SAO) filter, or an adaptive loop filter (ALF), which can effectively reduce a degree of distortion caused by quantization. Since the filtered reconstructed images are to be used as a reference for subsequently coded images to predict future image signals, the filtering operation is also referred to as loop filtering, that is, a filtering operation in a coding loop.

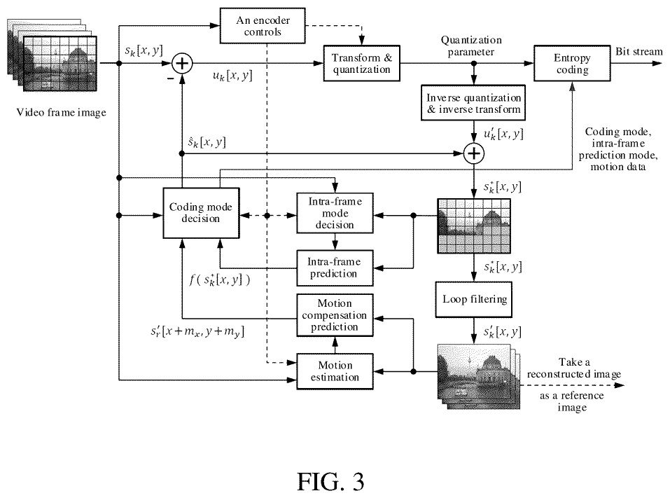

In an embodiment of the present disclosure, FIG. 3 is a basic flowchart of a video coder. In this process, intra prediction is used as an example for description. A difference operation is performed on an original image signal sₖ[x, y] and a predicted image signal ŝₖ[x, y] to obtain a residual signal uₖ[x, y]. The residual signal sₖ[x, y] is transformed and quantized to obtain a quantization coefficient. Entropy coding is performed on the quantization coefficient to obtain a coded bit stream, while inverse quantization and inverse transform are performed to obtain a reconstructed residual signal u′ₖ[x, y]. The predicted image signal ŝₖ[x, y] and the reconstructed residual signal u′ₖ[x, y] are superimposed to generate a reconstructed image signal

$${s}_{k}^{*} [ x , y ] .$$

The reconstructed image signal

$${s}_{k}^{*} [ x , y ]$$

is input to an intra-frame mode decision module and an intra prediction module for intra prediction processing, while filtering is performed through loop filtering, and a filtered image signal s′ₖ[x, y] is outputted. The filtered image signal s′ₖ[x, y] may be used as a next frame of reference image for motion estimation and motion compensation prediction. Then, a next frame of predicted image signal ŝₖ[x, y] is obtained based on a motion compensation prediction result s′ᵣ[x+mₓ, y+m_{y}] and an intra prediction result

$$f ( {s}_{k}^{*} [ x , y ] ) .$$

The above process is repeated until the coding is completed.

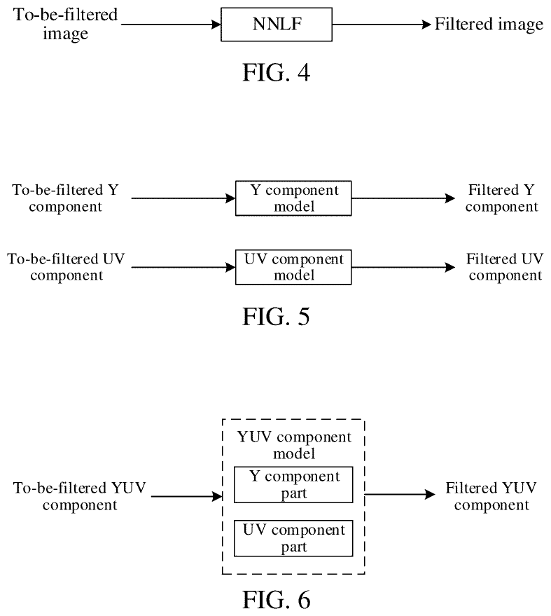

The above loop filtering may be implemented based on a neural network loop filter (NNLF). As shown in FIG. 4, after training on the NNLF is completed, a to-be-filtered image may be input to the trained NNLF, to obtain a filtered image. The NNLF usually uses a loss function to constrain the filtered image, so that the filtered image is restored to an original image as far as possible. The loss function measures a difference between a predicted value and a true value. A larger loss value between the predicted value and the true value indicates a larger difference. A training purpose is to reduce the loss value. In some embodiments, during training, the NNLF may construct a loss function of a model by using an L1 norm loss function and/or an L2 norm loss function.

To flexibly and separately process a luminance component and a chrominance component of an image, a method of separation of Luma and Chroma (SLC) may alternatively be used for the NNLF (hereinafter referred to as neural network filter). In various embodiments in the present disclosure, “neural network filter” may be referred as “neural network”).

For example, as shown in FIG. 5, a luminance component (Y) and chrominance components (Cb and Cr) respectively construct a neural network filter by using different network structures, and during training, different filter models may be separately trained for the luminance component (Y) and the chrominance components (Cb and Cr) to improve filtering performance for the luminance component and filtering performance of the chrominance components. As shown in FIG. 6, in the same network structure model, a luminance component and a chrominance component are separately processed by using different modules in a network.

In video coding and decoding based on a neural network, a neural network filter provided in a related art usually builds an overall network structure based on basic modules such as 3×3 convolution and residual blocks, to train the neural network filter. For the network structure of the neural network filter, repeatedly stacking the 3×3 convolution and the residual blocks can bring appreciable coding performance, but introduce excessively high operation complexity. By limiting a quantity of repetitions of the 3×3 convolution and the residual blocks, namely, by specifying operation complexity, it is also difficult to obtain high coding and decoding performance. Therefore, the technical solutions of the embodiments of the present disclosure provide a new filtering solution based on a neural network, which can obtain relative high coding performance and does not introduce excessive complexity, thereby facilitating improving video coding and decoding efficiency.

Here, the neural network belongs to artificial intelligence (AI). AL involves a theory, a method, a technology, and an application system that use a digital computer or a machine controlled by the digital computer to simulate, extend, and expand human intelligence, perceive an environment, acquire knowledge, and use knowledge to obtain an optimal result. In other words, AI is a comprehensive technology in computer science and attempts to understand the essence of intelligence and produce a new intelligent machine that can react in a mode similar to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. An artificial intelligence software technology mainly includes some major directions such as a computer vision technology, a speech processing technology, a natural language processing technology, and machine learning/deep learning, automated driving, and smart transportation.

Machine learning (ML) is a multi-field interdiscipline, and relates to a plurality of disciplines such as the probability theory, statistics, the approximation theory, convex analysis, and the algorithm complexity theory. ML specializes in studying how a computer simulates or implements a human learning behavior to obtain new knowledge or skills, and reorganize an existing knowledge structure, so as to keep improving its performance. ML is the core of AI, is a basic way to make the computer intelligent, and is applied to various fields of AI. The ML and the deep learning generally include technologies such as an artificial neural network, a confidence network, reinforcement learning, transfer learning, inductive learning, and learning from demonstration. The neural network filter in the embodiments of the present disclosure is a machine learning/deep learning-based filter.

The implementation details of the technical solutions of the embodiments of the present disclosure are described in detail below.

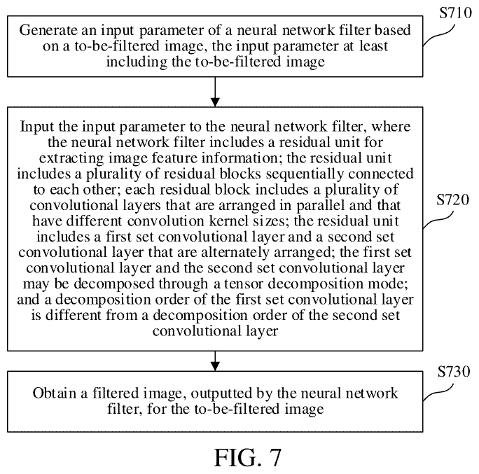

FIG. 7 is a flowchart of a filtering method based on a neural network according to an embodiment of the present disclosure. The filtering method based on the neural network may be performed by a device with a computing function, for example, may be performed by a terminal device or a server. For ease of description, the following makes an explanation by using an example in which an executive body is a filtering device. Referring to FIG. 7, the filtering method based on the neural network at least includes operation S710 to operation S730. Detailed descriptions are as follows:

In operation S710, the filtering device generates an input parameter of a neural network filter based on a to-be-filtered image.

In an embodiment of the present disclosure, the to-be-filtered image may be an image obtained by decoding by a video playback end, or may be a captured image. Alternatively, the to-be-filtered image may be a to-be-filtered reconstructed image, namely, an image generated by superimposing a reconstructed residual image obtained after inverse quantization and inverse transform with a predicted image. For example, in the flow shown in FIG. 3, the reconstructed image is the image signal

$${s}_{k}^{*} [ x , y ]$$

generated by superimposing the predicted image signal ŝₖ[x, y] with the reconstructed residual signal u′ₖ[x, y]. The to-be-filtered reconstructed image obtained by decoding may be played, or may be played and provide a reference for subsequent image prediction.

In some embodiments, an input parameter of the neural network filter may include at least one type of the following information: boundary strength information, a slide quantization parameter (QP), a base quantization parameter, a frame type (i.e., IPB) of the to-be-filtered image, and/or a predicted image (i.e., prediction) corresponding to the to-be-filtered image when the to-be-filtered image is a reconstructed image.

The frame type of the to-be-filtered image is configured for representing whether the reconstructed image is an I frame, a P frame, or a B frame. In the flow shown in FIG. 3, the predicted image corresponding to the reconstructed image is ŝₖ[x, y].

In some embodiments, the to-be-filtered image may alternatively be used as a type of information in the input parameter.

In operation S720, the to-be-filtered image is filtered based on the input parameter through the neural network filter, the neural network filter including a residual unit for extracting image feature information, the residual unit including a plurality of residual blocks sequentially connected to each other, each residual block at least including a plurality of convolutional layers that are arranged in parallel and that have different convolution kernel sizes, the residual unit including a first set convolutional layer and a second set convolutional layer that are alternately arranged, and the first set convolutional layer being different from the second set convolutional layer. For example, a decomposition order of the first set convolutional layer is different from a decomposition order of the second set convolutional layer.

In various embodiments in the present disclosure, a residual unit may be called as a residual network, which is a neural network for extracting image feature information. The residual (neural) network may include a plurality of residual blocks, and each residual block may include one or more convolutional layers.

In some implementations, the operation/step S720 may include filtering the to-be-filtered image based on the input parameter through the neural network, the neural network comprising a residual network for extracting image feature information, the residual network comprising a plurality of residual blocks sequentially connected to each other, each residual block comprising a plurality of convolutional layers that are arranged in parallel and that have different convolution kernel sizes, the residual network comprising a first set convolutional layer and a second set convolutional layer that are alternately arranged, and the first set convolutional layer being different from the second set convolutional layer.

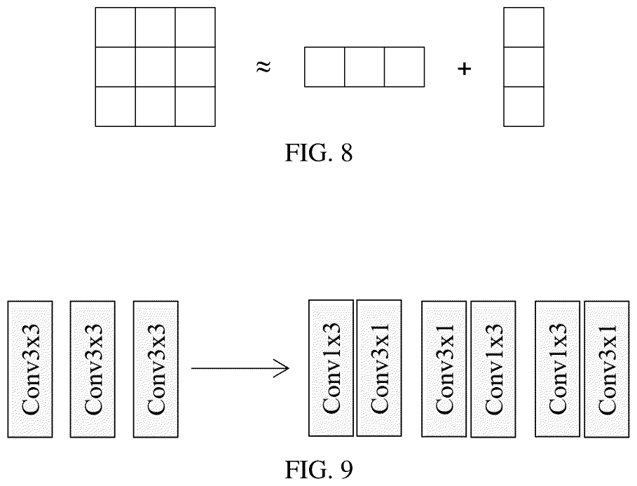

In some embodiments, the first set convolutional layer and the second set convolutional layer may be decomposed through a tensor decomposition mode. The tensor decomposition mode may use canonical polyamic decomposition (CPD). CPD is a classic tensor decomposition mode, and may be configured for reducing a convolution calculation amount in a neural network. As shown in FIG. 8, according to the principle of the CPD, a 3×3 convolution may be approximately represented by a 1×3 convolution and a 3×1 convolution, thereby effectively reducing complexity of a convolution operation without significantly reducing network performance.

In some embodiments, a decomposition order of the first set convolutional layer is different from a decomposition order of the second set convolutional layer, so that the first set convolutional layer and the second set convolutional layer may be alternately decomposed by using the CPD. As shown in FIG. 9, three 3×3 convolutions may be alternately decomposed according to the principle of the CPD, to obtain a 1×3 convolutional layer, a 3×1 convolutional layer, a 3×1 convolutional layer, a 1×3 convolutional layer, a 1×3 convolutional layer, and a 3×1 convolutional layer. For example, the first set convolutional layer may be a 1×3 convolutional layer connected to a 3×1 convolutional layer, and the second set convolutional layer may be a 3×1 convolutional layer connected to a 1×3 convolutional layer. Alternatively, the first set convolutional layer may be a 3×1 convolutional layer connected to a 1×3 convolutional layer, and the second set convolutional layer may be a 1×3 convolutional layer connected to a 3×1 convolutional layer.

In this embodiment of the present disclosure, since the residual blocks at least include the plurality of convolutional layers that are arranged in parallel and that have the different convolution kernel sizes, the neural network filter may obtain feature information on a plurality of stages of receptive fields through the residual blocks, thus improving generalization performance of the neural network filter. Furthermore, since the residual unit includes the first set convolutional layer and the second set convolutional layer that are arranged alternately and that can be decomposed through the tensor decomposition mode, and the decomposition orders of the first set convolutional layer and the second set convolutional layer are different, while reducing operation complexity of the neural network filter, impact of asymmetry introduced by tensor decomposition can be reduced and a filtering effect can be enhanced, thereby facilitating improving video coding and decoding efficiency.

In various embodiments, for a convolutional neural network, a single element of an output feature map of each network layer is mapped to a region size of an input feature map; and the region size may be referred as a receptive field. If convolution window sizes (namely, convolution kernel sizes) are different, a quantity of processed elements of the input feature map is also different. To be specific, convolutional layers having different convolution kernel sizes usually have different receptive field sizes.

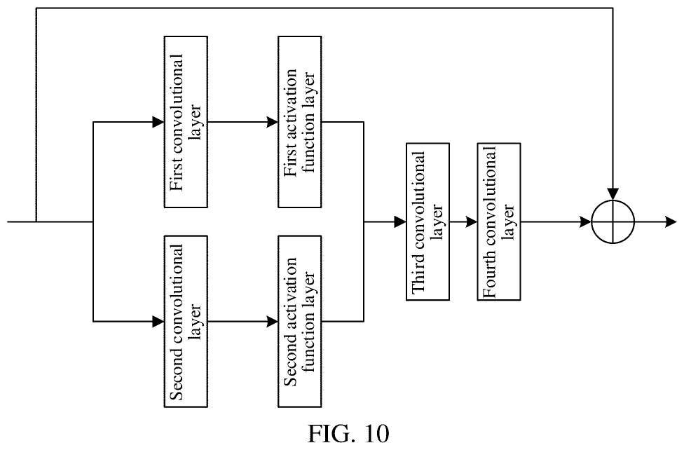

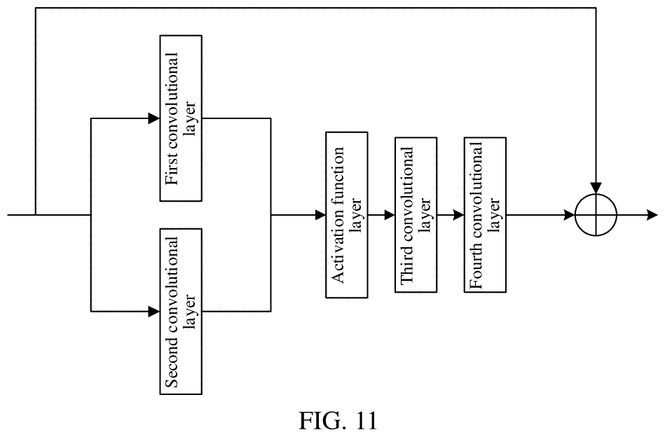

In some embodiments, as shown in FIG. 10 and FIG. 11, the plurality of convolutional layers include a first convolutional layer and a second convolutional layer. Each residual block further includes a first activation function layer connected to the first convolutional layer, a second activation function layer connected to the second convolutional layer, and a third convolutional layer and a fourth convolutional layer that are sequentially connected. An input end of the first convolutional layer and an input end of the second convolutional layer are connected to each other and are used as input ends of the residual blocks. The first convolutional layer and the second convolutional layer receive feature information of the input parameter. The feature information of the input parameter includes the image feature information. The first activation function layer and the second activation function layer are the same activation function layer or two activation function layers independent of each other. An output end of the first activation function layer or an output end of the second activation function layer is connected to an input end of the third convolutional layer. An input parameter of the residual block and output data of the fourth convolutional layer are superimposed and are used as output data of the residual block.

In some embodiments, as shown in FIG. 10, the first activation function layer and the second activation function layer may be two activation function layers independent of each other.

In some embodiments, as shown in FIG. 11, the first activation function layer and the second activation function layer may be the same activation function layers.

Here, each of the first activation function and the second activation function may be a parameter rectified linear unit (PReLU), a rectified linear unit (ReLU), a Gaussian error linear unit (GeLU), or the like. This embodiment of the present disclosure does not limit this.

In some embodiments, the two first convolutional layers of two adjacent residual blocks are respectively the first set convolutional layer and the second set convolutional layer, and/or the two fourth convolutional layers of two adjacent residual blocks are respectively the first set convolutional layer and the second set convolutional layer, alternatively, for the same residual block, the first convolutional layer is the first set convolutional layer, and the fourth convolutional layer is the second set convolutional layer. To be specific, in this embodiment of the present disclosure, at least one of the first convolutional layer, the second convolutional layer, and the fourth convolutional layer includes a convolutional layer decomposed through the tensor decomposition mode, and decomposition orders of the first convolutional layer and the second convolutional layer are different. For example, in two adjacent residual blocks, the first convolutional layer of a residual block may be a 1×3 convolution connected to a 3×1 convolution, and the first convolutional layer of the other residual block may be a 3×1 convolution connected to a 1×3 convolution. For another example, for the same residual block, the first convolutional layer may be a 1×3 convolution connected to a 3×1 convolution, and the fourth convolutional layer may be a 3×1 convolution connected to a 1×3 convolution.

In some embodiments, a convolution kernel size of the first convolutional layer is n×n. A convolution kernel size of the second convolutional layer is m×m, m and n being integers greater than or equal to 1, and m≠n. For example, a convolution kernel size of the first convolutional layer is 3×3, and a convolution kernel size of the second convolutional layer is 1×1. In another embodiment of the present disclosure, values of m and n may be, for example, 1, 3, 5, or 7.

In some embodiments, the first convolutional layer includes: two convolutional sublayers obtained by decomposing a convolutional layer with a convolution kernel size of n1×n2 through the tensor decomposition mode. A convolution kernel size of the second convolutional layer is m1×m2, and m1, m2, n1, and n2 are integers greater than or equal to 1.

In some embodiments, the two convolutional sublayers include: a convolutional layer with a convolution kernel size of 1×n1, and a convolutional layer with a convolution kernel size of n2×1.

In some embodiments, n1≠n2. For example, the first convolutional layer includes a 3×1 convolutional sublayer and a 1×2 convolutional sublayer that are obtained by decomposing a convolutional layer with a convolution kernel size of 3×2 through the tensor decomposition mode.

In some embodiments, n1=n2. For example, the first convolutional layer includes a 3×1 convolutional sublayer and a 1×3 convolutional sublayer obtained by decomposing a convolutional layer with a convolution kernel size of 3×3 through the tensor decomposition mode.

In some embodiments, the first convolutional layer includes: two convolutional sublayers obtained by decomposing the convolutional layer with the convolution kernel size of n×n through tensor decomposition and group convolution; and A convolution kernel size of the second convolutional layer is m×m, m and n being integers greater than or equal to 1, and m≠n. For example, the first convolutional layer includes a 3×1 convolutional sublayer and a 1×3 convolutional sublayer that are obtained by decomposing a convolutional layer with a convolution kernel size of 3×3, and a convolution kernel size of the second convolutional layer is 1×1. In another embodiment of the present disclosure, values of m and n may be, for example, 1, 3, 5, or 7.

In some embodiments, the two convolutional sublayers obtained by decomposing the convolutional layer with the convolution kernel size of n×n through the tensor decomposition and the group convolution include: a convolutional layer that has a convolution kernel size of 1×n and that performs group convolution, and a convolutional layer that has a convolution kernel size of n×1 and that performs group convolution.

In some embodiments, the first convolutional layer includes: three convolutional sublayers obtained by decomposing the convolutional layer with the convolution kernel size of n×n through tensor decomposition and depth-wise separable convolution; and A convolution kernel size of the second convolutional layer is m×m, m and n being integers greater than or equal to 1, and m≠n. For example, the first convolutional layer includes a 3×1 convolutional sublayer and a 1×3 convolutional sublayer that are obtained by decomposing a convolutional layer with a convolution kernel size of 3×3, and a convolution kernel size of the second convolutional layer is 1×1. In another embodiment of the present disclosure, values of m and n may be, for example, 1, 3, 5, or 7.

The depth-wise separable convolution (DSC) is an improved algorithm of standard convolution. First, convolution is respectively performed on each channel by using a given convolution kernel size, and results are combined. This part is referred to as depth convolution. Subsequently, the depth-wise separable convolution performs ordinary/standard convolution by using a 1×1 convolution kernel and outputs a feature map. This part is referred to as the pointwise convolution. The DSC can effectively reduce complexity of a convolution operation.

In some embodiments, the convolutional layer with the convolution kernel size of n×n may be first decomposed through the depth-wise separable convolution to obtain a convolutional layer that has a convolution kernel size of n×n and that performs group convolution, and a convolutional layer with a convolution kernel size of 1×1. Then, the convolutional layer that has the convolution kernel size of n×n and that performs group convolution is decomposed through the tensor decomposition into a convolutional layer that has a convolution kernel size of 1×n and that performs group convolution, and a convolutional layer that has a convolution kernel size of n×1 and that performs group convolution.

In some embodiments, the above fourth convolutional layer may be a convolutional layer with a convolution kernel size of k×k, where k is an integer greater than or equal to 1, for example, may be 1, 3, 5, or 7. Alternatively, the fourth convolutional layer may be a plurality of convolutional sublayers obtained by decomposition through tensor decomposition and/or depth-wise separable convolution. For example, the fourth convolutional layer may include two convolutional sublayers obtained by decomposing a convolutional layer with a convolution kernel size of k×k through the tensor decomposition mode, and convolution kernel sizes of the two convolutional sublayers may be respectively 1×k and k×1. Alternatively, the fourth convolutional layer includes a convolutional sublayer obtained by decomposing the convolutional layer with the convolution kernel size of k×k through group convolution. Alternatively, the fourth convolutional layer may include two convolutional sublayers obtained by decomposing a convolutional layer with a convolution kernel size of k×k through depth-wise separable convolution. The two convolutional sublayers may be a convolutional layer that has a convolution kernel size of k×k and that performs group convolution, and a convolutional layer with a convolution kernel size of 1×1. Alternatively, the fourth convolutional layer includes two convolutional sublayers obtained by decomposing a convolutional layer with a convolution kernel size of k×k through tensor decomposition and group convolution. The two convolutional sublayers may be a convolutional layer that has a convolution kernel size of 1×k and that performs group convolution, and a convolutional layer that has a convolution kernel size of k×1 and that performs group convolution. Alternatively, the fourth convolutional layer includes three convolutional sublayers obtained by decomposing a convolutional layer with a convolution kernel size of k×k through tensor decomposition and depth-wise separable convolution. The three convolutional sublayers may be a convolutional layer that has a convolution kernel size of 1×k and that performs group convolution, a convolutional layer that has a convolution kernel size of k×1 and that performs group convolution, and a convolutional layer with a convolution kernel size of 1×1.

In some embodiments, the residual unit in the neural network filter may be luminance-chrominance separated, namely, the residual unit in the neural network filter includes residual units respectively specific to an image luminance component and an image chrominance component. In this case, a residual block structure included in the residual unit specific to the image luminance component may be the same as or different from a residual block structure included in the residual unit specific to the image chrominance component.

In some embodiments, the neural network filter may further include: a shallow feature extraction unit, the shallow feature extraction unit including at least one convolutional layer, and the shallow feature extraction unit being configured to: extract shallow feature information of the input parameter and input the shallow feature information to the residual unit.

In some implementations, the method may further include extracting, by the device, shallow feature information of the input parameter with a shallow feature extraction block in the neural network, the shallow feature extraction block comprising at least one convolutional layer; and inputting, by the device, the extracted shallow feature information to the residual network.

In some embodiments, the at least one convolutional layer of the shallow feature extraction unit may be a convolutional layer with a convolution kernel size of r×r, where r is an integer greater than or equal to 1, for example, may be 1, 3, 5, or 7. The at least one convolutional layer of the shallow feature extraction unit may alternatively be a plurality of convolutional sublayers obtained by decomposition through tensor decomposition, and/or depth-wise separable convolution and group convolution. For example, the at least one convolutional layer of the shallow feature extraction unit includes a convolutional layer obtained by decomposing the convolutional layer with the convolution kernel size of r×r through group convolution. Alternatively, the at least one convolutional layer of the shallow feature extraction unit includes two convolutional sublayers obtained by decomposing the convolutional layer with the convolution kernel size of r×r through the tensor decomposition mode or depth-wise separable convolution. Alternatively, the at least one convolutional layer of the shallow feature extraction unit includes two convolutional sublayers obtained by decomposing the convolutional layer with the convolution kernel size of r×r through the tensor decomposition mode and group convolution. Alternatively, the at least one convolutional layer of the shallow feature extraction unit includes three convolutional sublayers obtained by decomposing the convolutional layer with the convolution kernel size of r×r through the tensor decomposition mode and depth-wise separable convolution.

In some embodiments, the input parameter includes a plurality of types of information; the at least one convolutional layer includes a plurality of shallow feature extraction convolutional layers; each type of information corresponds to at least one shallow feature extraction convolutional layer; and the shallow feature extraction convolutional layer is configured for extracting shallow feature information of corresponding information.

In some embodiments, the input parameter includes a plurality of types of information; the shallow feature extraction unit further includes a connection layer; the connection layer is configured for: connecting the plurality of types of information and inputting the plurality of types of information that are connected to the at least one convolutional layer; and the at least one convolutional layer is configured for: extracting shallow feature information of the plurality of types of information that are connected, and inputting the shallow feature information to the residual unit.

In some embodiments, the neural network filter may further include: a feature mapping unit, configured to map image feature information outputted by the residual unit. In some embodiments, if the residual unit in the neural network filter is simultaneously specific to both an image luminance component and an image chrominance component, feature mapping units respectively specific to the image luminance component and the image chrominance component may be respectively configured. The feature mapping unit specific to the image luminance component and the feature mapping unit specific to the image chrominance component are respectively connected to the residual unit, and the feature mapping unit specific to the image luminance component and the feature mapping unit specific to the image chrominance component respectively process output data of the residual unit.

In various embodiments in the present disclosure, feature mapping unit(s) may be referred to as feature mapping block(s) (or feature mapping network(s)). In some implementations, the neural network may further include: a feature mapping block, configured to map image feature information outputted by the residual network. In some embodiments, if the residual network in the neural network is simultaneously specific to both an image luminance component and an image chrominance component, feature mapping blocks respectively specific to the image luminance component and the image chrominance component may be respectively configured. The feature mapping block specific to the image luminance component and the feature mapping block specific to the image chrominance component are respectively connected to the residual network, and the feature mapping block specific to the image luminance component and the feature mapping block specific to the image chrominance component respectively process output data of the residual network.

In some embodiments, the feature mapping unit (or feature mapping units/blocks respectively specific to the image luminance component and/or the image chrominance component) specific to includes a convolutional layer with a convolution kernel size of s×s, where s is an integer greater than or equal to 1, for example, may be 1, 3, 5, or 7. Alternatively, the convolutional layer included in the feature mapping unit specific to may be a plurality of convolutional sublayers obtained by decomposition through tensor decomposition and/or depth-wise separable convolution, and group convolution. For example, the feature mapping unit specific to includes two convolutional sublayers obtained by decomposing the convolutional layer with the convolution kernel size of s×s by using tensor decomposition. Alternatively, the feature mapping unit specific to include a convolutional sublayer obtained by decomposing the convolutional layer with the convolution kernel size of s×s by using group convolution. Alternatively, the feature mapping unit specific to includes two convolutional sublayers obtained by decomposing the convolutional layer with the convolution kernel size of s×s by using depth-wise separable convolution. Alternatively, the feature mapping unit specific to includes two convolutional sublayers obtained by decomposing the convolutional layer with the convolution kernel size of s×s by using tensor decomposition and group convolution; or three convolutional sublayers obtained by decomposing the convolutional layer with the convolution kernel size of s×s through tensor decomposition and depth-wise separable convolution.

In some embodiments, if the residual unit in the neural network filter includes residual units respectively specific to an image luminance component and an image chrominance component, feature mapping units specific to the image luminance component and the image chrominance component may be respectively configured. Furthermore, the feature mapping unit specific to the image luminance component is connected to the residual unit specific to the image luminance component, and the feature mapping unit specific to the image luminance component processes output data of the residual unit specific to the image luminance component; the feature mapping unit specific to the image chrominance component is connected to the residual unit specific to the image chrominance component, and the feature mapping unit specific to the image chrominance component processes output data specific to the image chrominance component (or output data of the residual unit specific to the image chrominance component).

In operation S730, a filtered image, outputted by the neural network filter, for the reconstructed image is obtained.

In an embodiment of the present disclosure, during training, the neural network filter needs to use a parameter that is the same as a parameter used during application as an input. Specifically, in a training stage, an input parameter (the input parameter is adjusted according to a use scene of the neural network filter, namely, which is the same as a parameter used during use of the neural network filter) for training the neural network filter is generated based on a sample image. Then, the obtained input parameter is inputted to the neural network filter, and a parameter of the neural network filter is adjusted according to a loss value between an output of the neural network filter and an expected filtering result image corresponding to the sample image, and this process is repeated until the neural network filter satisfies a convergence condition.

Here, the technical solution of an embodiment shown in FIG. 7 may be applied to a loop filter in a video coding and decoding process. Namely, loop filtering is performed in video coding and decoding by using a filtering method shown in FIG. 7. Alternatively, the technical solution of an embodiment shown in FIG. 7 may be applied to post-processing a video or an image. To be specific, filtering an image obtained by decoding by a video playback end, an image captured by a terminal device, or another image.

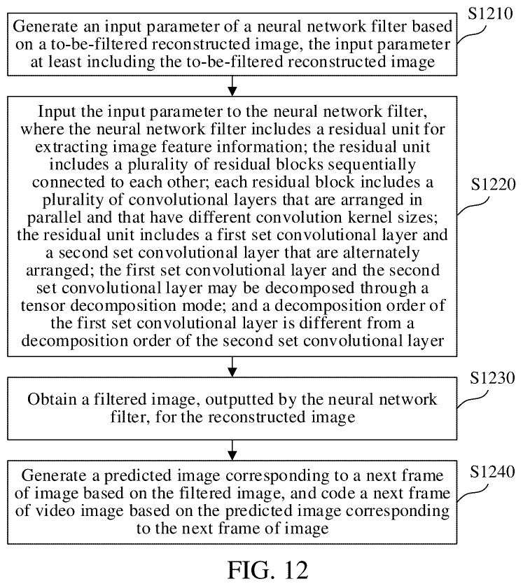

Based on the filtering method based on the neural network shown in FIG. 7, an embodiment of the present disclosure further provides a video coding method. The video coding method may be performed by a device with a computing function, such as a coding device. A specific flow is shown in FIG. 12, including operation S1210 to operation S1240:

In operation S1210, an input parameter of a neural network filter is generated based on a to-be-filtered reconstructed image.

For specific implementation details of this operation, refer to operation S710 above. This will not be elaborated here.

In operation S1220, the reconstructed image is filtered based on the input parameter through the neural network filter, the neural network filter including a residual unit for extracting image feature information, the residual unit including a plurality of residual blocks sequentially connected to each other, each residual block at least including a plurality of convolutional layers that are arranged in parallel and that have different convolution kernel sizes, the residual unit including a first set convolutional layer and a second set convolutional layer that are alternately arranged, and the first set convolutional layer being different from the second set convolutional layer.

For specific implementation details of this operation, refer to operation S720 above. This will not be elaborated here.

In operation S1230, a filtered image, outputted by the neural network filter, for the reconstructed image is obtained.

For specific implementation details of this operation, refer to operation S730 above. This will not be elaborated here.

In operation S1240, a predicted image corresponding to a next frame of image is generated based on the filtered image, and the next frame of video image is coded based on the predicted image corresponding to the next frame of image.

In some embodiments, after the filtered image is obtained, refer to the flow shown in FIG. 3. To be specific, the filtered image of the reconstructed image is used as a reference image of the next frame of image for motion estimation and motion compensation prediction. Then, a predicted image of the next frame of image is obtained based on a motion compensation prediction result and an intra-frame prediction result, and the flow shown in FIG. 3 continues to be repeated until coding on a video image is completed.

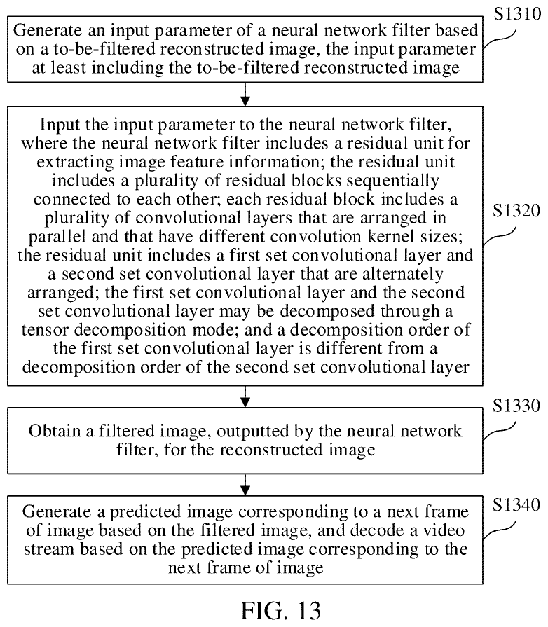

Correspondingly, based on the filtering method based on the neural network shown in FIG. 7, an embodiment of the present disclosure further provides a video decoding method. The video decoding method may be performed by a device with a computing function, such as a decoding device. A specific flow is shown in FIG. 13, including operation S1310 to operation S1340:

In operation S1310, an input parameter of a neural network filter is generated based on a to-be-filtered reconstructed image.

For specific implementation details of this operation, refer to operation S710 above. This will not be elaborated here.

In operation S1320, the reconstructed image is filtered based on the input parameter through the neural network filter, the neural network filter including a residual unit for extracting image feature information, the residual unit including a plurality of residual blocks sequentially connected to each other, each residual block at least including a plurality of convolutional layers that are arranged in parallel and that have different convolution kernel sizes, the residual unit including a first set convolutional layer and a second set convolutional layer that are alternately arranged, and the first set convolutional layer being different from the second set convolutional layer.

For specific implementation details of this operation, refer to operation S720 above. This will not be elaborated here.

In operation S1330, a filtered image, outputted by the neural network filter, for the to-be-filtered image is obtained.

For specific implementation details of this operation, refer to operation S730 above. This will not be elaborated here.

In operation S1340, a predicted image corresponding to a next frame of image is generated based on the filtered image, and a video stream is decoded based on the predicted image corresponding to the next frame of image.

In some embodiments, after the filtered image of the reconstructed image is obtained, the filtered image of the reconstructed image is used as a reference image of the next frame of image for motion estimation and motion compensation prediction, and then the predicted image of the next frame of image is obtained based on a motion compensation prediction result and an intra-frame prediction result. The predicted image of the next frame of image and a reconstructed residual signal obtained by performing inverse quantization and inverse transform are superimposed again to generate a next frame of reconstructed image, and this process is repeated, to decode the video stream.

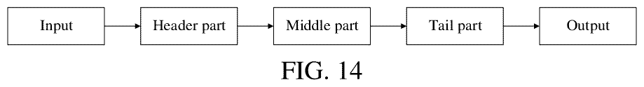

Implementation details that are not described in detail in the embodiments of the present disclosure will be described again below in combination with FIG. 14 to FIG. 26:

In the embodiments of the present disclosure, a filtering solution based on a neural network is provided. A novel neural network filter structure may be designed by a luminance-chrominance separation mode, a multi-stage receptive field mode, an alternate CPD mode, or the like, thereby achieving a good balance between coding performance and operation complexity. This solution may be applied to a video codec or a product for pre-processing and post-processing of a video.

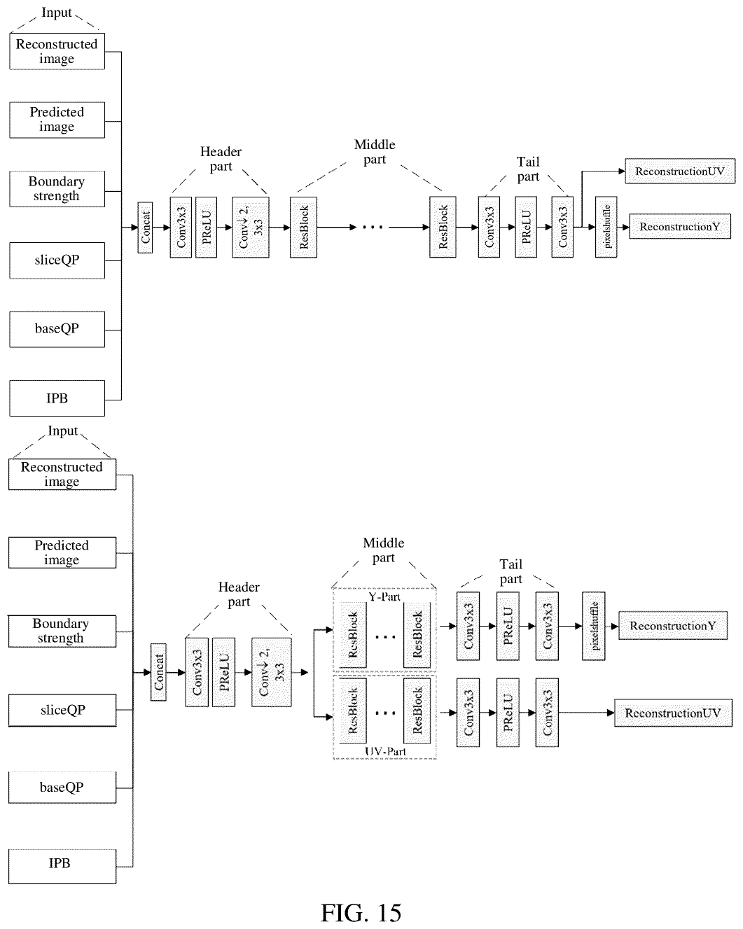

In some embodiments, FIG. 14 and FIG. 15 show a structure of a neural network filter according to an embodiment of the present disclosure. The neural network filter includes an input part, a header part, a middle part, a tail part, and an output part.

In some embodiments, the input part of the neural network filter may include two parts: image information and edge information. The image information includes a to-be-filtered reconstructed image (reconstruction), and a predicted image corresponding to the to-be-filtered reconstructed image (prediction), and boundary strength, so as to provide main image content for filtering of a coded/decoded reconstructed image. The edge information includes a sliceQP, a baseQP, and an IPB. The sliceQP and the baseQP are configured for representing a quantization parameter and distortion level of a to-be-filtered reconstructed image, and IPB is configured for representing a coding type (i.e., one of an I frame, a P frame, and a B frame) of the to-be-filtered reconstructed image.

Here, the input part of the neural network filter includes but is not limited to the foregoing several types of information. In addition, the to-be-filtered reconstructed image in the input part of the neural network filter is necessary, and other information may be deleted or added according to an actual requirement.

In some embodiments, the header part of the neural network filter is configured for extracting shallow feature information of an input parameter, and may include two 3×3 convolutional layers and a PReLU activation layer. The input parameter is cascaded (concat) and transmitted into a header part of the neural network filter for feature extraction, to obtain a shallow feature representation.

In some embodiments, the middle part of the neural network filter is an important backbone structure of a network, and may include a plurality of residual blocks (ResBlock). In some embodiments, the middle part may use a luminance-chrominance separation form. To be specific, a luminance component and a chrominance component are separately processed by using different modules Y-Part and UV-Part.

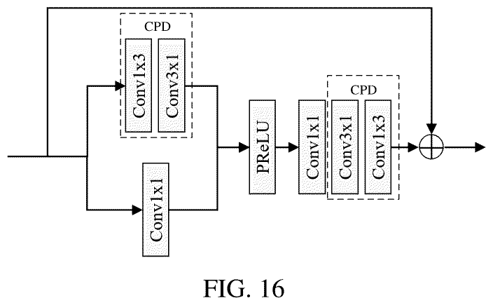

In an embodiment of the present disclosure, a structure of a residual block may be shown in FIG. 16. A 3×3 convolution is decomposed into a 3×1 convolution and a 1×3 convolution according to a principle of CPD, and alternate decomposition is performed in the same residual block, so that for the same residual block, a first convolutional layer is a 1×3 convolution and a 3×1 convolution, and a fourth convolutional layer is a 3×1 convolution and a 1×3 convolution.

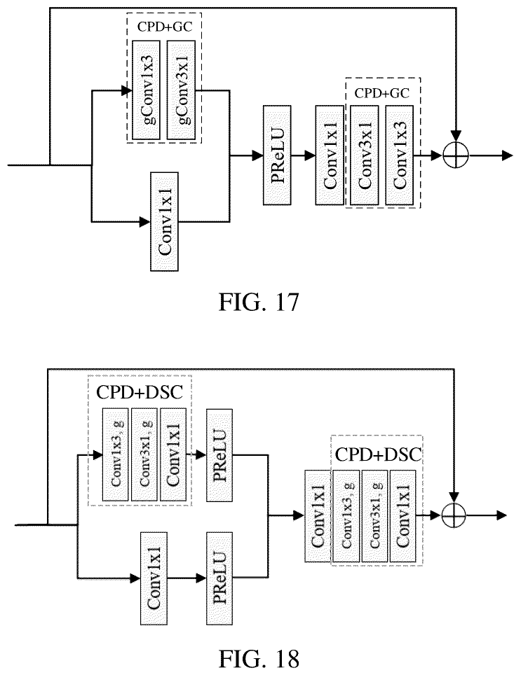

In an embodiment of the present disclosure, a structure of a residual block may be shown in FIG. 17. By simultaneously using CPD and group convolution (GC), a 3×3 convolution is decomposed into a 1×3 convolution and a 3×1 convolution that perform group convolution. Where g indicates that group convolution is used, namely, it is specified that the same parameter is used for convolution in a channel range, and alternate decomposition is performed in the same residual block, so that for the same residual block, a first convolutional layer is a 1×3 convolution and a 3×1 convolution that perform group convolution, and a fourth convolutional layer is a 3×1 convolution and a 1×3 convolution.

In an embodiment of the present disclosure, a structure of a residual block may be shown in FIG. 18. By simultaneously using CPD and DSC, a 3×3 convolution is decomposed into a 1×3 convolution that performs group convolution, a 3×1 convolution that performs group convolution, and a 1×1 convolution. Where g represents that group convolution is used. To be specific, it is specified that the same parameter is used for convolution in a channel range.

Here, residual blocks included in a Y-Part and a UV-Part in the middle part shown in FIG. 15 may use any structure in FIG. 16 to FIG. 18, or some residual blocks use any structure in FIG. 16 to FIG. 18. For example, the Y-Part includes four residual blocks, and the four residual blocks all use the structure shown in FIG. 16. Alternatively, two of the residual blocks use the structure shown in FIG. 17, and the other two residual blocks use the structure shown in FIG. 18.

In some embodiments, quantities and/or structures of residual blocks included in the Y-Part and the UV-Part may be the same or different. For example, different residual blocks are used in the Y-Part and the UV-Part in the middle part. For example, one or several residual blocks shown in FIG. 16 to FIG. 18 may be used in the Y-Part, and other residual blocks are used in the UV-Part.

In some embodiments, still referring to FIG. 15, when luminance and chrominance of the middle part are not separated, the same tail part structure may be used to obtain a luminance filtered image and a chrominance filtered image. When the luminance and chrominance of the middle part are separated, a tail part network of the neural network filter may use a luminance-chrominance separation form, to respectively obtain a luminance filtered image and a chrominance filtered image. In some embodiments, the tail part may include two convolutional layers and a PReLU activation layer, to map feature information with a large number of channels into image information with a small number of channels.

In some embodiments, a to-be-filtered reconstructed image (reconstruction) inputted by the neural network filter and a residual obtained by network learning are summated to obtain a final output of the network, namely, a filtered image. To be specific, in the neural network filter structure shown in FIG. 15, a neural network is configured for learning residual data. In this way, since a data volume of the residual data is small, processing efficiency of the neural network can be improved. In another embodiment of the present disclosure, an output of the tail part network of the neural network filter may alternatively be directly used as an output of the neural network filter. In this way, the neural network filter learns a difference between images before and after filtering.

Here, the structures of the residual blocks and the convolution kernel sizes in this embodiment of the present disclosure are merely examples. In another embodiment of the present disclosure, the structures and the convolution kernel sizes may be adjusted according to an actual application scene.

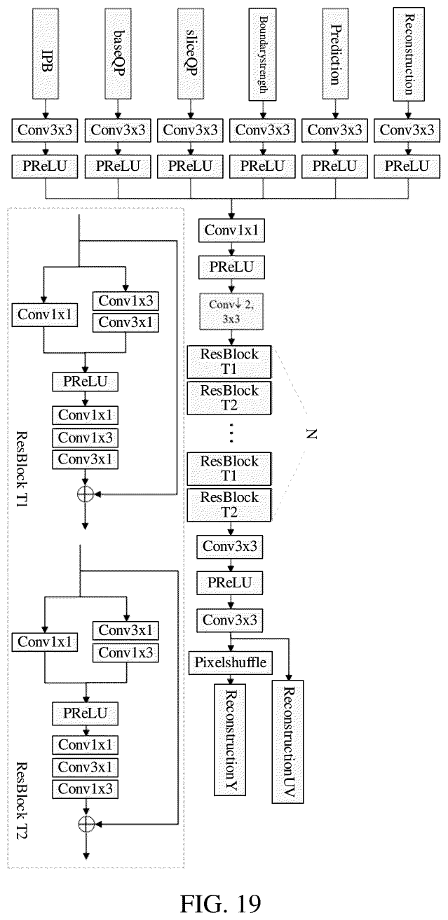

In some embodiments, as shown in FIG. 19 to FIG. 26, the header part of the neural network filter includes a plurality of 3×3 convolutional layers and a plurality of PReLU activation layers that respectively correspond to different inputs, and includes a 1×1 convolutional layer and a PReLU activation layer. The plurality of PReLU activation layers respectively corresponding to different inputs are jointly connected to the 1×1 convolutional layer.

In an embodiment of the present disclosure, a structure of the neural network filter is shown in FIG. 19. The middle part of the neural network filter includes a plurality of first residual blocks and a plurality of second residual blocks that are alternately arranged, and the tail part of the neural network filter is of a single-branch structure. ResBlockT1 represents a first residual block, and ResBlockT2 represents a second residual block. A first convolutional layer of ResBlockT1 includes a 1×3 convolution and a 3×1 convolution that are obtained by decomposing a 3×3 convolution according to the principle of the CPD, and a first convolutional layer of ResBlockT2 includes a 3×1 convolution and a 1×3 convolution that are obtained by decomposing a 3×3 convolution according to the principle of the CPD. The tail part includes two 3×3 convolutional layers and a PReLU activation layer.

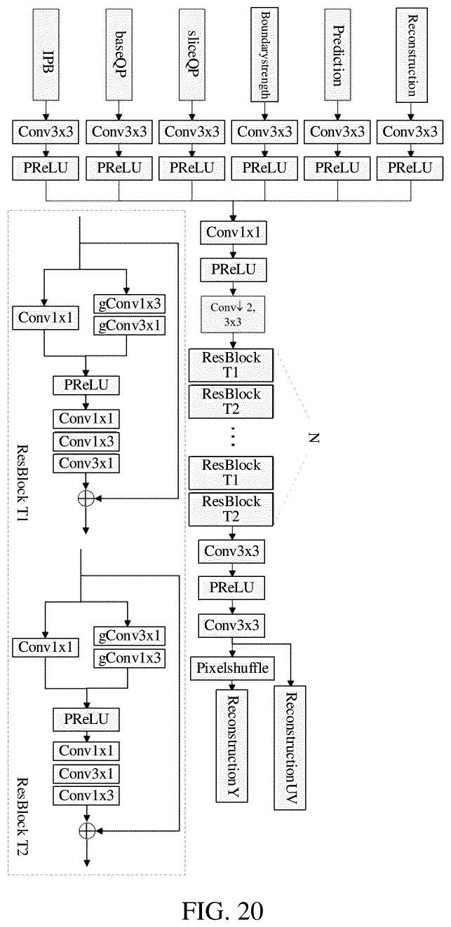

In an embodiment of the present disclosure, a structure of the neural network filter is shown in FIG. 20. The middle part of the neural network filter includes a plurality of first residual blocks and a plurality of second residual blocks that are alternately arranged and that are decomposed and use GC according to the principle of the CPD, and the tail part of the neural network filter us of a single-branch structure. ResBlockT1 represents a first residual block, and ResBlockT2 represents a second residual block. A first convolutional layer of ResBlockT1 includes a 1×3 convolution and a 3×1 convolution that are obtained by decomposing a 3×3 convolution by using the CPD and the GC and that perform group convolution, and a first convolutional layer of ResBlockT2 includes a 3×1 convolution and a 1×3 convolution that are obtained by decomposing a 3×3 convolution by using the CPD and the GC and that perform group convolution. The tail part includes two 3×3 convolutional layers and a PReLU activation layer.

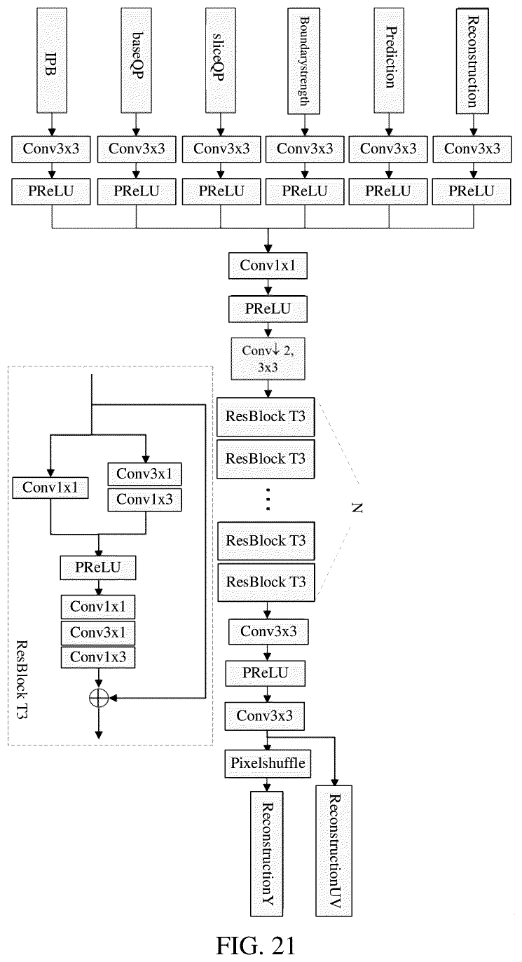

In an embodiment of the present disclosure, a structure of the neural network filter is shown in FIG. 21. The middle part of the neural network filter includes a plurality of residual blocks that are alternately decomposed according to the principle of the CPD. ResBlockT3 represents the residual block. To be specific, a first convolutional layer of ResBlockT3 includes a 1×3 convolution and a 3×1 convolution, and a fourth convolutional layer includes a 3×1 convolution and a 1×3 convolution. In addition, the tail part of the neural network filter is of a single-branch structure, and includes two 3×3 convolutional layers and a PReLU activation layer.

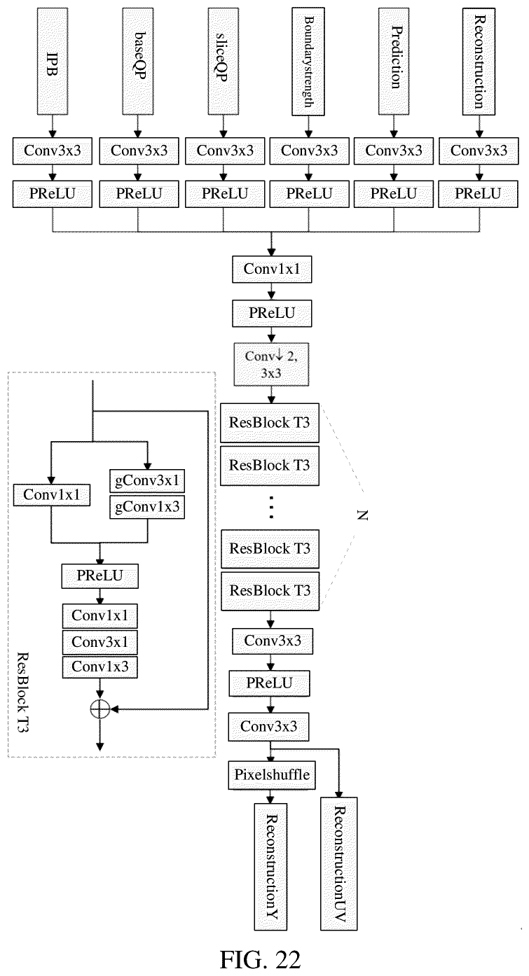

In an embodiment of the present disclosure, a structure of the neural network filter is shown in FIG. 22. The middle part of the neural network filter includes a plurality of residual blocks that are alternately decomposed according to the CPD and that are obtained by the GC. ResBlockT3 represents the residual block. To be specific, a first convolutional layer of ResBlockT3 includes a 1×3 convolution and a 3×1 convolution that are obtained by decomposing a 3×3 convolution by using the CPD and the GC and that perform group convolution, and a fourth convolutional layer includes a 3×1 convolution and a 1×3 convolution that are obtained by decomposing a 3×3 convolution by using the CPD and the GC and that perform group convolution. In addition, the tail part of the neural network filter is of a single-branch structure, and includes two 3×3 convolutional layers and a PReLU activation layer.

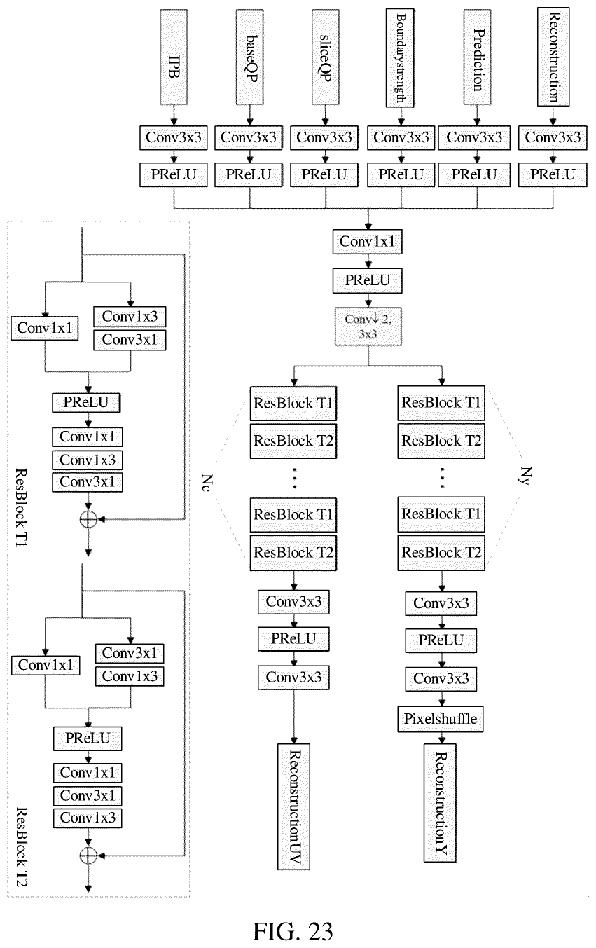

In an embodiment of the present disclosure, a structure of the neural network filter is shown in FIG. 23. The middle part of the neural network filter includes a plurality of first residual blocks and a plurality of second residual blocks that are alternately arranged, and the tail part of the neural network filter includes two branches. ResBlockT1 represents a first residual block, and ResBlockT2 represents a second residual block. A first convolutional layer of ResBlockT1 includes a 1×3 convolution and a 3×1 convolution that are obtained by decomposing a 3×3 convolution according to the principle of the CPD, and a first convolutional layer of ResBlockT2 includes a 3×1 convolution and a 1×3 convolution that are obtained by decomposing a 3×3 convolution according to the principle of the CPD. The two branches of the tail part include a luminance branch specific to an image luminance component and a chrominance branch specific to an image chrominance component, and the luminance branch and the chrominance branch respectively include two 3×3 convolutional layers and a PReLU activation layer.

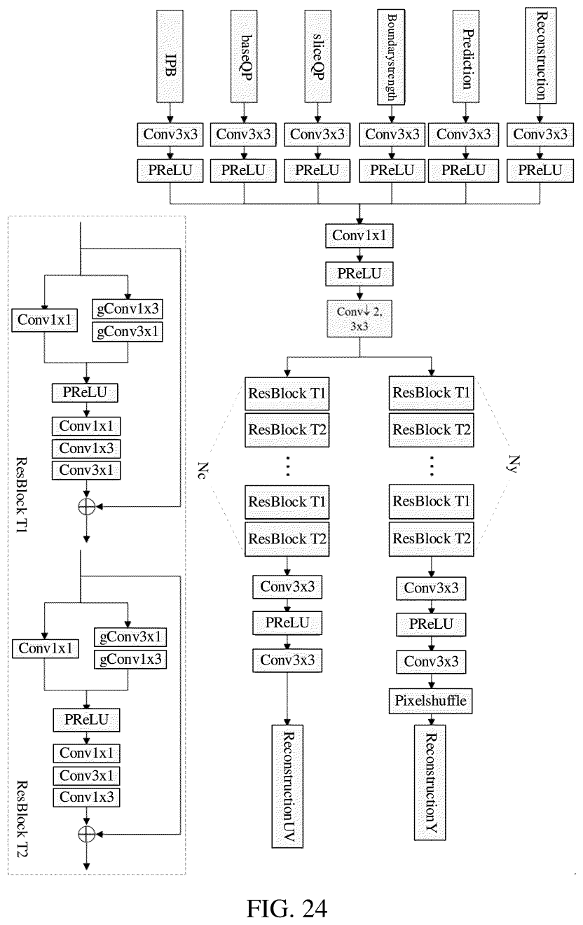

In an embodiment of the present disclosure, a structure of the neural network filter is shown in FIG. 24. The middle part of the neural network filter includes a plurality of first residual blocks and a plurality of second residual blocks that are alternately arranged and that are decomposed and use GC according to the principle of the CPD, and the tail part of the neural network filter us of a two-branch structure. ResBlockT1 represents a first residual block, and ResBlockT2 represents a second residual block. A first convolutional layer of ResBlockT1 includes a 1×3 convolution and a 3×1 convolution that are obtained by decomposing a 3×3 convolution by using the CPD and the GC and that perform group convolution, and a first convolutional layer of ResBlockT2 includes a 3×1 convolution and a 1×3 convolution that are obtained by decomposing a 3×3 convolution by using the CPD and the GC and that perform group convolution. The two branches of the tail part include a luminance branch specific to an image luminance component and a chrominance branch specific to an image chrominance component, and the luminance branch and the chrominance branch respectively include two 3×3 convolutional layers and a PReLU activation layer.

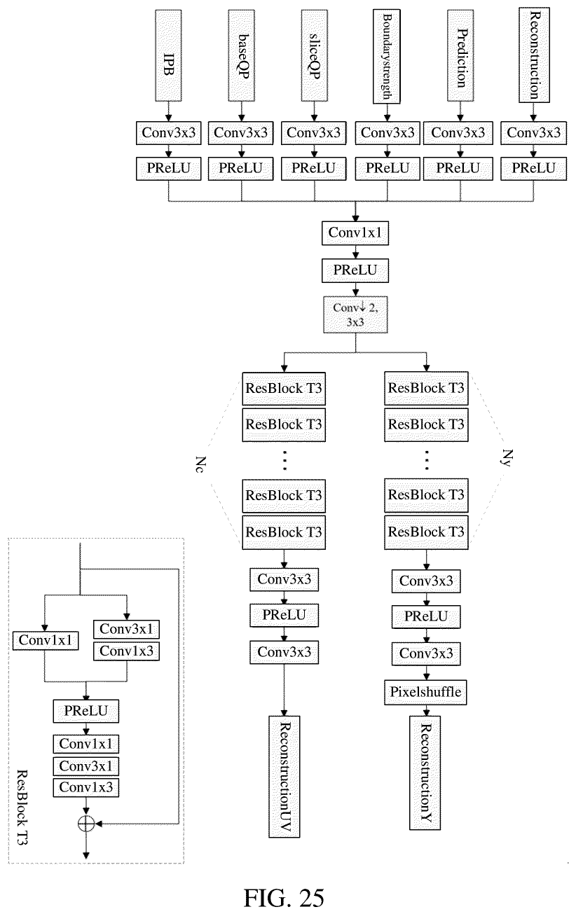

In an embodiment of the present disclosure, a structure of the neural network filter is shown in FIG. 25. The middle part of the neural network filter includes a plurality of residual blocks that are alternately decomposed according to the principle of the CPD. ResBlockT3 represents the residual block. To be specific, a first convolutional layer of ResBlockT3 includes a 1×3 convolution and a 3×1 convolution, and a fourth convolutional layer includes a 3×1 convolution and a 1×3 convolution. In addition, the tail part of the neural network filter includes two branches. The two branches of the tail part include a luminance branch specific to an image luminance component and a chrominance branch specific to an image chrominance component, and the luminance branch and the chrominance branch respectively include two 3×3 convolutional layers and a PReLU activation layer.

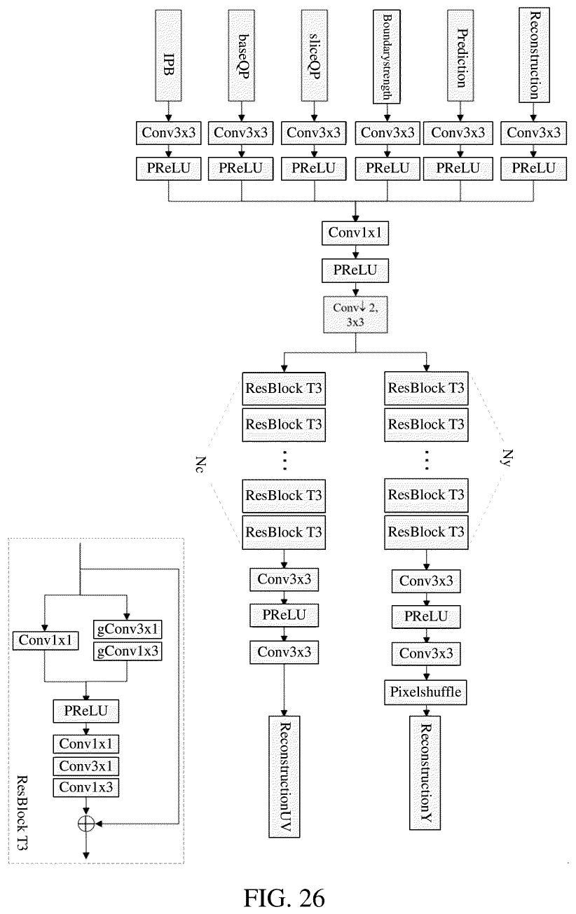

In an embodiment of the present disclosure, a structure of the neural network filter is shown in FIG. 26. The middle part of the neural network filter includes a plurality of third residual blocks that are alternately decomposed according to the CPD and that are obtained by the GC. ResBlockT3 represents the residual block. To be specific, a first convolutional layer of ResBlockT3 includes a 1×3 convolution and a 3×1 convolution that are obtained by decomposing a 3×3 convolution by using the CPD and the GC and that perform group convolution, and a fourth convolutional layer includes a 3×1 convolution and a 1×3 convolution that are obtained by decomposing a 3×3 convolution by using the CPD and the GC and that perform group convolution. In addition, the tail part of the neural network filter includes two branches. The two branches of the tail part include a luminance branch specific to an image luminance component and a chrominance branch specific to an image chrominance component, and the luminance branch and the chrominance branch respectively include two 3×3 convolutional layers and a PReLU activation layer.

The following describes an apparatus embodiment of the present disclosure, which may be configured for performing the method in the foregoing embodiment of the present disclosure. For details not disclosed in the apparatus embodiment of the present disclosure, refer to the foregoing embodiment of the method of the present disclosure.

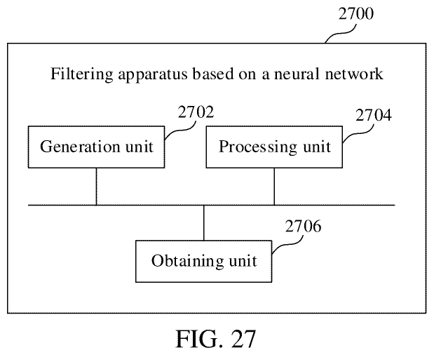

FIG. 27 is a block diagram of a filtering apparatus based on a neural network according to an embodiment of the present disclosure. The filtering apparatus based on the neural network may be applied to a device with a computing function, for example, a filtering device.

Referring to FIG. 27, a filtering apparatus 2700 based on a neural network according to an embodiment of the present disclosure includes: a generation unit 2702, a processing unit 2704, and an obtaining unit 2706.

The generation unit 2702 is configured to generate an input parameter of a neural network filter based on a to-be-filtered image. The processing unit 2704 is configured to filter the to-be-filtered image based on the input parameter through the neural network filter, the neural network filter including a residual unit for extracting image feature information, the residual unit including a plurality of residual blocks sequentially connected to each other, each residual block at least including a plurality of convolutional layers that are arranged in parallel and that have different convolution kernel sizes, the residual unit including a first set convolutional layer and a second set convolutional layer that are alternately arranged, and the first set convolutional layer being different from the second set convolutional layer. The obtaining unit 2706 is configured to obtain a filtered image, outputted by the neural network filter, for the to-be-filtered image.

In some embodiments of the present disclosure, based on the foregoing solution, at least one of the first set convolutional layer and the second set convolutional layer includes a convolutional layer obtained by performing decomposition through a tensor decomposition mode, and decomposition orders of the first set convolutional layer and the second set convolutional layer are different.

In some embodiments of the present disclosure, based on the foregoing solution, the input parameter includes at least one type of the following information:
boundary strength information, a slice quantization parameter, a base quantization parameter, a frame type of the to-be-filtered image, and a predicted image corresponding to the to-be-filtered image when the to-be-filtered image is a reconstructed image.

In some embodiments of the present disclosure, based on the foregoing solution, the plurality of convolutional layers include a first convolutional layer and a second convolutional layer; each residual block further includes a first activation function layer connected to the first convolutional layer, a second activation function layer connected to the second convolutional layer, and a third convolutional layer and a fourth convolutional layer that are sequentially connected, and an output end of the first activation function layer and an output end of the second activation function layer are connected to an input end of the third convolutional layer; the first convolutional layer and the second convolutional layer receive feature information of the input parameter; the feature information of the input parameter includes the image feature information; the first activation function layer and the second activation function layer are a same activation function layer or two activation function layers independent of each other; and an input parameter of the residual block and output data of the fourth convolutional layer are superimposed and are used as output data of the residual block.

In some embodiments of the present disclosure, based on the foregoing solution, the two first convolutional layers of two adjacent residual blocks are respectively the first set convolutional layer and the second set convolutional layer, and/or the two fourth convolutional layers of two adjacent residual blocks are respectively the first set convolutional layer and the second set convolutional layer; alternatively, for the same residual block, the first convolutional layer is the first set convolutional layer, and the fourth convolutional layer is the second set convolutional layer.

In some embodiments of the present disclosure, based on the foregoing solution, a convolution kernel size of the first convolutional layer is n×n. A convolution kernel size of the second convolutional layer is m×m, m and n being integers greater than or equal to 1, and m≠n.

In some embodiments of the present disclosure, based on the foregoing solution, the first convolutional layer includes: two convolutional sublayers obtained by decomposing the convolutional layer with the convolution kernel size of n×n through tensor decomposition and group convolution. A convolution kernel size of the second convolutional layer is m×m, m and n being integers greater than or equal to 1, and m≠n.

In some embodiments of the present disclosure, based on the foregoing solution, the two convolutional sublayers include: a convolutional layer that has a convolution kernel size of 1×n and that performs group convolution, and a convolutional layer that has a convolution kernel size of n×1 and that performs group convolution.

In some embodiments of the present disclosure, based on the foregoing solution, the first convolutional layer includes: three convolutional sublayers obtained by decomposing the convolutional layer with the convolution kernel size of n×n through tensor decomposition and depth-wise separable convolution. A convolution kernel size of the second convolutional layer is m×m, m and n being integers greater than or equal to 1, and m≠n.

In some embodiments of the present disclosure, based on the foregoing solution, the three convolutional sublayers include: a convolutional layer that has a convolution kernel size of 1×n and that performs group convolution, a convolutional layer that has a convolution kernel size of n×1 and that performs group convolution, and a convolutional layer with a convolution kernel size of 1×1.

In some embodiments of the present disclosure, based on the foregoing solution, a convolution kernel size of the fourth convolutional layer is k×k; alternatively,
the fourth convolutional layer includes two convolutional sublayers obtained by decomposing the convolutional layer with the convolution kernel size of k×k through the tensor decomposition mode; alternatively,
the fourth convolutional layer includes a convolutional sublayer obtained by decomposing the convolutional layer with the convolution kernel size of k×k through group convolution; alternatively,
the fourth convolutional layer includes two convolutional sublayers obtained by decomposing the convolutional layer with the convolution kernel size of k×k through depth-wise separable convolution; alternatively,
the fourth convolutional layer includes two convolutional sublayers obtained by decomposing the convolutional layer with the convolution kernel size of k×k through tensor decomposition and group convolution; alternatively,
the fourth convolutional layer includes three convolutional sublayers obtained by decomposing the convolutional layer with the convolution kernel size of k×k through tensor decomposition and depth-wise separable convolution,
k being an integer greater than or equal to 1.

In some embodiments of the present disclosure, based on the foregoing solution, the residual unit includes residual units respectively specific to an image luminance component and an image chrominance component. A residual block structure included in the residual unit specific to the image luminance component may be the same as or different from a residual block structure included in the residual unit specific to the image chrominance component.

In some embodiments of the present disclosure, based on the foregoing solution, the neural network filter further includes: a shallow feature extraction unit, the shallow feature extraction unit including at least one convolutional layer, and the shallow feature extraction unit being configured to: extract shallow feature information of the input parameter and input the shallow feature information to the residual unit.

In some embodiments of the present disclosure, based on the foregoing solution, the input parameter includes a plurality of types of information; the at least one convolutional layer includes a plurality of shallow feature extraction convolutional layers; each type of information corresponds to at least one shallow feature extraction convolutional layer; and the shallow feature extraction convolutional layer is configured for extracting shallow feature information of corresponding information.

In some embodiments of the present disclosure, based on the foregoing solution, the input parameter includes a plurality of types of information; the shallow feature extraction unit further includes a connection layer; the connection layer is configured for: connecting the plurality of types of information and inputting the plurality of types of information that are connected to the at least one convolutional layer; and the at least one convolutional layer is configured for: extracting shallow feature information of the plurality of types of information that are connected, and inputting the shallow feature information to the residual unit.

In some embodiments of the present disclosure, based on the foregoing solution, the residual unit is simultaneously specific to both an image luminance component and an image chrominance component.

The neural network filter further includes: feature mapping units respectively specific to an image luminance component and an image chrominance component and configured to map image feature information outputted by the residual unit. The feature mapping unit specific to the image luminance component and the feature mapping unit specific to the image chrominance component respectively process output data of the residual unit.

In some embodiments of the present disclosure, based on the foregoing solution, the residual unit includes residual units respectively specific to an image luminance component and an image chrominance component. The neural network filter further includes: feature mapping units respectively specific to an image luminance component and an image chrominance component and configured to map image feature information outputted by the residual unit. the feature mapping unit specific to the image luminance component processes output data of the residual unit for the image luminance component; and the feature mapping unit specific to the image chrominance component processes output data of the residual unit for the image chrominance component.

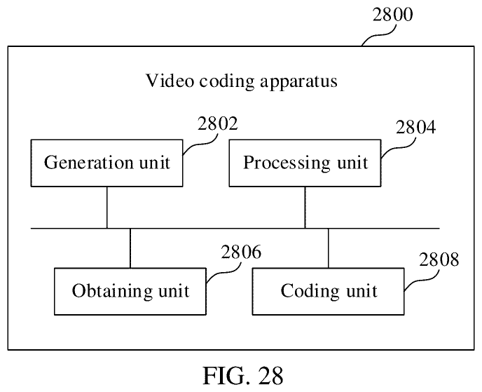

FIG. 28 is a block diagram of a video coding apparatus according to an embodiment of the present disclosure. The video coding apparatus may be applied to a device with a computing function, for example, a coding device.

Referring to FIG. 28, a video coding apparatus 2800 according to an embodiment of the present disclosure includes: a generation unit 2802, a processing unit 2804, an obtaining unit 2806, and a coding unit 2808.

The generation unit 2802 is configured to generate an input parameter of a neural network filter based on a to-be-filtered reconstructed image. The processing unit 2804 is configured to filter the reconstructed image based on the input parameter through the neural network filter, the neural network filter including a residual unit for extracting image feature information, the residual unit including a plurality of residual blocks sequentially connected to each other, each residual block at least including a plurality of convolutional layers that are arranged in parallel and that have different convolution kernel sizes, the residual unit including a first set convolutional layer and a second set convolutional layer that are alternately arranged, and the first set convolutional layer being different from the second set convolutional layer. The obtaining unit 2806 is configured to obtain a filtered image, outputted by the neural network filter, for the reconstructed image. The coding unit 2808 is configured to: generate a predicted image corresponding to a next frame of image based on the filtered image, and code the next frame of video image based on the predicted image corresponding to the next frame of image.

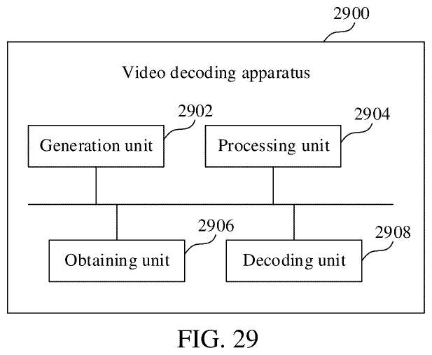

FIG. 29 is a block diagram of a video decoding apparatus according to an embodiment of the present disclosure. The video decoding apparatus may be applied to a device with a computing function, for example, a decoding device.

Referring to FIG. 29, a video decoding apparatus 2900 according to an embodiment of the present disclosure includes: a generation unit 2902, a processing unit 2904, an obtaining unit 2906, and a decoding unit 2908.

The generation unit 2902 is configured to generate an input parameter of a neural network filter based on a to-be-filtered reconstructed image. The processing unit 2904 is configured to filter the reconstructed image based on the input parameter through the neural network filter, the neural network filter including a residual unit for extracting image feature information, the residual unit including a plurality of residual blocks sequentially connected to each other, each residual block at least including a plurality of convolutional layers that are arranged in parallel and that have different convolution kernel sizes, the residual unit including a first set convolutional layer and a second set convolutional layer that are alternately arranged, and the first set convolutional layer being different from the second set convolutional layer. The obtaining unit 2906 is configured to obtain a filtered image, outputted by the neural network filter, for the reconstructed image. a decoding unit 2908 is configured to: generate a predicted image corresponding to a next frame of image based on the filtered image, and decode a video stream based on the predicted image corresponding to the next frame of image.

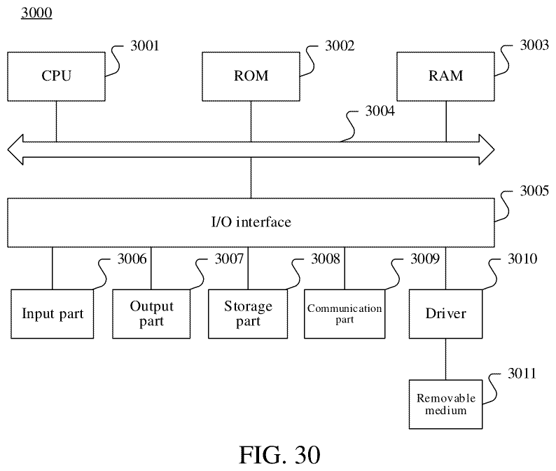

FIG. 30 is a schematic structural diagram of a computer system adapted to implement an electronic device according to an embodiment of the present disclosure.

Here, the computer system 3000 of the electronic device shown in FIG. 30 is merely an example, and does not constitute any limitation on functions and use ranges of this embodiment of the present disclosure.

As shown in FIG. 30, the computer system 3000 includes a central processing unit (CPU) 3001, which may perform various suitable actions and processing based on a program stored in a read-only memory (ROM) 3002 or a program loaded from a storage part 3008 into a random access memory (RAM) 3003, for example, perform the method in the foregoing embodiment. The RAM 3003 further stores various programs and data required for system operations. The CPU 3001, the ROM 3002, and the RAM 3003 are connected to each other through a bus 3004. An input/output (I/O) interface 3005 is also connected to the bus 3004.

The following components may be connected to the I/O interface 3005: an input part 3006 including a keyboard, a mouse, and the like; an output part 3007 including a cathode ray tube (CRT), a liquid crystal display (LCD), a speaker, and the like; a storage part 3008 including hard disk drive, and the like; and a communication part 3009 including a network interface card such as a local area network (LAN) card and a modem. The communication part 3009 performs communication processing by using a network such as the Internet. A driver 3010 is also connected to the I/O interface 3005 as required. A removable medium 3011, such as a magnetic disk, an optical disc, a magneto-optical disk, or a semiconductor memory, is installed on the drive 3010 as required, so that a computer program read from the removable medium is installed into the storage part 3008 as required.

Particularly, according to an embodiment of the present disclosure, the processes described in the following by referring to the flowcharts may be implemented as computer software programs. For example, this embodiment of the present disclosure includes a computer program product, including a computer program carried on a computer-readable medium, and the computer program is configured for performing the method shown in the flowchart. In such an embodiment, the computer program may be downloaded and installed from a network through the communication part 3009, and/or installed from the removable medium 3011. When the computer program is executed by the CPU 3001, the various functions defined in the system of the present disclosure are executed.

Here, the computer-readable medium shown in the embodiments of the present disclosure may be a computer-readable signal medium or a computer-readable storage medium or any combination of the two. The computer-readable storage medium may be, for example, but is not limited to, an electric, magnetic, optical, electromagnetic, infrared, or semi-conductive system, apparatus, or component, or any combination of the above. More specific examples of the computer-readable storage medium may include but are not limited to: an electrical connection with one or more wires, a portable computer disk, a hard disk, a RAM, a ROM, an erasable programmable read-only memory (EPROM), a flash memory, an optical fiber, a portable compact disc read-only memory (CD-ROM), an optical storage device, a magnetic storage device, or any appropriate combination thereof. In the present disclosure, the computer-readable storage medium may be any tangible medium containing or storing a computer program, and the computer program may be used by or used in combination with an instruction execution system, an apparatus, or a device. In the present disclosure, the computer-readable signal medium may include a data signal transmitted in a baseband or as part of a carrier, and stores a computer-readable computer program. A data signal propagated in such a way may assume a plurality of forms, including, but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a program that is used by or used in conjunction with an instruction execution system, an apparatus, or a device. The computer program included in the computer-readable medium may be transmitted by using any suitable medium, including, but not limited to, a wireless medium, a wired medium, or any suitable combination of the above.

The flowcharts and block diagrams in the accompanying drawings illustrate possible system architectures, functions and operations that may be implemented by a system, a method, and a computer program product according to various embodiments of the present disclosure. Each box in a flowchart or a block diagram may represent a module, a program segment, or a part of code. The module, the program segment, or the part of code includes one or more executable instructions configured for implementing specified logic functions. In some implementations used as substitutes, functions annotated in boxes may alternatively occur in a sequence different from that annotated in an accompanying drawing. For example, actually two boxes shown in succession may be performed basically in parallel, and sometimes the two boxes may be performed in a reverse sequence. This is determined by a related function. Each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

A related unit described in the embodiments of the present disclosure may be implemented in a software manner, or may be implemented in a hardware manner, and the unit described can also be set in a processor. Names of the units do not constitute a limitation on the units in a specific case.

In another aspect, the present disclosure further provides a computer-readable medium. The computer-readable medium may be included in the electronic device described in the above embodiments, or may exist alone without being assembled into the electronic device. The computer-readable medium carries one or more computer programs. The one or more computer programs, when executed by the electronic device, cause the electronic device to implement the method in the foregoing embodiment.

An embodiment of the present disclosure further provides a computer program product including instructions. When run on a computer, the instructions enable the computer to perform the method according to the method embodiments.

In various embodiments in the present disclosure, a unit (block) may refer to a software unit (block), a hardware unit (block), or a combination thereof. A software unit (block) may include a computer program or part of the computer program that has a predefined function and works together with other related parts to achieve a predefined goal, such as those functions described in this disclosure. A hardware unit (block) may be implemented using processing circuitry and/or memory configured to perform the functions described in this disclosure. Each unit can be implemented using one or more processors (or processors and memory). Likewise, a processor (or processors and memory) can be used to implement one or more units. Moreover, each unit can be part of an overall unit that includes the functionalities of the unit. The description here also applies to the term unit and other equivalent terms.

Although a plurality of modules or units of a device configured to perform actions are discussed in the foregoing detailed description, such division is not mandatory. Actually, according to the implementations of the present disclosure, the features and functions of two or more modules or units described above may be specifically implemented in one module or unit. On the contrary, the features and functions of one module or unit described above may be further divided to be embodied by a plurality of modules or units.

In some other embodiments, a computer-readable medium comprising instructions which, when executed by a computer, cause the computer to carry out a portion or all of the above methods. The computer-readable medium may be referred to as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software. In various embodiments in the present disclosure, the term “processor” may mean one processor that performs the defined functions, steps, or operations or a plurality of processors that collectively perform defined functions, steps, or operations, such that the execution of the individual defined functions may be divided amongst such plurality of processors.

According to the foregoing descriptions of the implementations, a person skilled in the art may readily understand that the exemplary implementations described herein may be implemented by using software, or may be implemented by combining software and necessary hardware. Therefore, the technical solutions of the implementations of the present disclosure may be implemented in a form of a software product. The software product may be stored in a non-volatile storage medium (which may be a CD-ROM, a USB flash drive, a removable hard disk, or the like) or on the network, including several instructions for instructing a computing device (which may be a personal computer, a server, a touch terminal, a network device, or the like) to perform the methods according to the implementations of the present disclosure.

After considering the specification and practicing the implementations of the present disclosure, a person skilled in the art may easily conceive of other implementations of the present disclosure. The present disclosure is intended to cover any variations, uses, or adaptive changes of the present disclosure. These variations, uses, or adaptive changes follow the general principles of the present disclosure and include common general knowledge or common technical means in the art, which are not disclosed in the present disclosure.

The present disclosure is not limited to the precise structures described above and shown in the accompanying drawings, and various modifications and changes can be made without departing from the scope of the present disclosure. The scope of the present disclosure is subject only to the appended claims.

What is claimed is:

1. A method for video decoding, comprising:
generating, by a device comprising a memory storing instructions and a processor in communication with the memory, an input parameter of a neural network based on a to-be-filtered image;
filtering, by the device, the to-be-filtered image based on the input parameter through the neural network, the neural network comprising a residual network for extracting image feature information, the residual network comprising a plurality of residual blocks sequentially connected to each other, each residual block comprising a plurality of convolutional layers that are arranged in parallel and that have different convolution kernel sizes, the residual network comprising a first set convolutional layer and a second set convolutional layer that are alternately arranged, and the first set convolutional layer being different from the second set convolutional layer; and
outputting, by the device, a filtered image corresponding to the to-be-filtered image from the neural network corresponding to the to-be-filtered image.

2. The method according to claim 1, wherein:
at least one of the first set convolutional layer and the second set convolutional layer comprises a convolutional layer obtained by performing decomposition through a tensor decomposition mode, and decomposition orders of the first set convolutional layer and the second set convolutional layer are different.

3. The method according to claim 1, wherein the input parameter comprises at least one type of the following information:
boundary strength information, a slice quantization parameter, a base quantization parameter, a frame type of the to-be-filtered image, or a predicted image corresponding to the to-be-filtered image when the to-be-filtered image is a reconstructed image.

4. The method according to any one of claims 1, wherein:
the plurality of convolutional layers comprise a first convolutional layer and a second convolutional layer; each residual block further comprises a first activation function layer connected to the first convolutional layer, a second activation function layer connected to the second convolutional layer, and a third convolutional layer and a fourth convolutional layer that are sequentially connected, and an output end of the first activation function layer and an output end of the second activation function layer are connected to an input end of the third convolutional layer; and
the first convolutional layer and the second convolutional layer receive feature information of the input parameter; the feature information of the input parameter comprises the image feature information; the first activation function layer and the second activation function layer are a same activation function layer or two activation function layers independent of each other;
and an input parameter of the residual block and output data of the fourth convolutional layer are superimposed and are used as output data of the residual block.

5. The method according to claim 4, wherein:
two first convolutional layers of two adjacent residual blocks are respectively the first set convolutional layer and the second set convolutional layer, or two fourth convolutional layers of two adjacent residual blocks are respectively the first set convolutional layer and the second set convolutional layer, or
for the same residual block, the first convolutional layer is the first set convolutional layer, and the fourth convolutional layer is the second set convolutional layer.

6. The method according to claim 4, wherein:
a convolution kernel size of the first convolutional layer is n×n; and a convolution kernel size of the second convolutional layer is m×m, m and n being integers greater than or equal to 1, and m≠n.

7. The method according to claim 4, wherein:
the first convolutional layer comprises: two convolutional sublayers obtained by decomposing the convolutional layer with the convolution kernel size of n×n through a tensor decomposition mode; the two convolutional sublayers comprise: a convolutional layer with a convolution kernel size of 1×n, and a convolutional layer with a convolution kernel size of n×1; and
a convolution kernel size of the second convolutional layer is m×m, m and n being integers greater than or equal to 1, and m≠n.

8. The method according to claim 4, wherein:
the first convolutional layer comprises: two convolutional sublayers obtained by decomposing the convolutional layer with the convolution kernel size of n×n through tensor decomposition and group convolution; the two convolutional sublayers comprise: a convolutional layer that has a convolution kernel size of 1×n and that performs group convolution, and a convolutional layer that has a convolution kernel size of n×1 and that performs group convolution; and
a convolution kernel size of the second convolutional layer is m×m, m and n being integers greater than or equal to 1, and m≠n.

9. The method according to claim 4, wherein:
the first convolutional layer comprises: three convolutional sublayers obtained by decomposing the convolutional layer with the convolution kernel size of n×n through tensor decomposition and depth-wise separable convolution;
the three convolutional sublayers comprise: a convolutional sublayer that has a convolution kernel size of 1×n and that performs group convolution, a convolutional sublayer that has a convolution kernel size of n×1 and that performs group convolution, and a convolutional sublayer with a convolution kernel size of 1×1; and
a convolution kernel size of the second convolutional layer is m×m, m and n being integers greater than or equal to 1, and m≠n.

10. The method according to claim 1, further comprising:
extracting, by the device, shallow feature information of the input parameter with a shallow feature extraction block in the neural network, the shallow feature extraction block comprising at least one convolutional layer; and
inputting, by the device, the extracted shallow feature information to the residual network.

11. The method according to claim 10, wherein:
the input parameter comprises a plurality of types of information;
the at least one convolutional layer comprises a plurality of shallow feature extraction convolutional layers;
each type of information corresponds to at least one shallow feature extraction convolutional layer; and
the shallow feature extraction convolutional layer is configured for extracting shallow feature information of corresponding information.

12. The method according to claim 1, further comprising:
generating, by the device, a predicted image corresponding to a next frame of image based on the filtered image.

13. An apparatus for video decoding, the apparatus comprising:
a memory storing instructions; and
a processor in communication with the memory, wherein, when the processor executes the instructions, the processor is configured to cause the apparatus to perform:
generating an input parameter of a neural network based on a to-be-filtered image;
filtering the to-be-filtered image based on the input parameter through the neural network, the neural network comprising a residual network for extracting image feature information, the residual network comprising a plurality of residual blocks sequentially connected to each other, each residual block comprising a plurality of convolutional layers that are arranged in parallel and that have different convolution kernel sizes, the residual network comprising a first set convolutional layer and a second set convolutional layer that are alternately arranged, and the first set convolutional layer being different from the second set convolutional layer; and
outputting a filtered image corresponding to the to-be-filtered image from the neural network corresponding to the to-be-filtered image.

14. The apparatus according to claim 13, wherein:
at least one of the first set convolutional layer and the second set convolutional layer comprises a convolutional layer obtained by performing decomposition through a tensor decomposition mode, and decomposition orders of the first set convolutional layer and the second set convolutional layer are different.

15. The apparatus according to claim 13, wherein the input parameter comprises at least one type of the following information:
boundary strength information, a slice quantization parameter, a base quantization parameter, a frame type of the to-be-filtered image, or a predicted image corresponding to the to-be-filtered image when the to-be-filtered image is a reconstructed image.

16. The apparatus according to claim 13, wherein:
the plurality of convolutional layers comprise a first convolutional layer and a second convolutional layer; each residual block further comprises a first activation function layer connected to the first convolutional layer, a second activation function layer connected to the second convolutional layer, and a third convolutional layer and a fourth convolutional layer that are sequentially connected, and an output end of the first activation function layer and an output end of the second activation function layer are connected to an input end of the third convolutional layer; and
the first convolutional layer and the second convolutional layer receive feature information of the input parameter; the feature information of the input parameter comprises the image feature information; the first activation function layer and the second activation function layer are a same activation function layer or two activation function layers independent of each other; and an input parameter of the residual block and output data of the fourth convolutional layer are superimposed and are used as output data of the residual block.

17. A non-transitory computer-readable storage medium, storing computer-readable instructions, wherein, the computer-readable instructions, when executed by a processor, are configured to cause the processor to perform:
generating an input parameter of a neural network based on a to-be-filtered image;
filtering the to-be-filtered image based on the input parameter through the neural network, the neural network comprising a residual network for extracting image feature information, the residual network comprising a plurality of residual blocks sequentially connected to each other, each residual block comprising a plurality of convolutional layers that are arranged in parallel and that have different convolution kernel sizes, the residual network comprising a first set convolutional layer and a second set convolutional layer that are alternately arranged, and the first set convolutional layer being different from the second set convolutional layer; and
outputting a filtered image corresponding to the to-be-filtered image from the neural network corresponding to the to-be-filtered image.

18. The non-transitory computer-readable storage medium according to claim 17, wherein:
at least one of the first set convolutional layer and the second set convolutional layer comprises a convolutional layer obtained by performing decomposition through a tensor decomposition mode, and decomposition orders of the first set convolutional layer and the second set convolutional layer are different.

19. The non-transitory computer-readable storage medium according to claim 17, wherein the input parameter comprises at least one type of the following information:
boundary strength information, a slice quantization parameter, a base quantization parameter, a frame type of the to-be-filtered image, or a predicted image corresponding to the to-be-filtered image when the to-be-filtered image is a reconstructed image.

20. The non-transitory computer-readable storage medium according to claim 17, wherein:
the plurality of convolutional layers comprise a first convolutional layer and a second convolutional layer; each residual block further comprises a first activation function layer connected to the first convolutional layer, a second activation function layer connected to the second convolutional layer, and a third convolutional layer and a fourth convolutional layer that are sequentially connected, and an output end of the first activation function layer and an output end of the second activation function layer are connected to an input end of the third convolutional layer; and
the first convolutional layer and the second convolutional layer receive feature information of the input parameter; the feature information of the input parameter comprises the image feature information; the first activation function layer and the second activation function layer are a same activation function layer or two activation function layers independent of each other; and an input parameter of the residual block and output data of the fourth convolutional layer are superimposed and are used as output data of the residual block.
